(19) United States
(12) Patent Application Publication
(10) Pub. No.: US 2026/0065080 A1
(43) Pub. Date: Mar. 5, 2026

(54) INTEGRATED MEMORY AND COMPUTE SYSTEM FOR OPTIMIZED NEURAL NETWORK COMPUTATION

(71) Applicant: Intel Corporation, Santa Clara, CA (US)

(72) Inventors: Yaron Klein, Rosh Haayin (IL); Yuval Vered, Tel-Aviv (IL); Yoni Elron, Hadera (IL); Ashley Munch, Shrewsbury, MA (US); John Crouter, Fair Oaks, CA (US); Carleton L. Molnar, Northborough, MA (US); Urmi Pandya, Wheaton, IL (US); Avi Salmon, Kiriat Ata (IL); Stanislav Borisover, Haifa (IL); Tatyana Druz, Hadera (IL)

(73) Assignee: Intel Corporation, Santa Clara, CA (US)

(21) Appl. No.: 19/381,224

(22) Filed: Nov. 6, 2025

Related U.S. Application Data
(60) Provisional application No. 63/754,808, filed on Feb. 6, 2025.

(51) Int. Cl. G06N 3/10; G06N 3/048

(52) U.S. Cl. CPC G06N 3/10; G06N 3/048

(57) ABSTRACT

An integrated circuit (IC) device may implement a deep neural network (DNN). The IC device may be a three-dimensional (3D) integrated system that includes a memory die and logic die. The memory die may include memory blocks, such as sequential random-access memory blocks or a sequential read-only memory blocks. The logic die may include an interface unit, a vector operation unit, compute units (e.g., multiply-accumulate units), and an interconnect fabric with adders. The interface unit may receive the input of the DNN and transfer the input to the vector operation unit. The vector operation unit may perform one or more vector operations of the DNN based on the input. The compute units and adders may perform matrix multiplication operations of the DNN based on the vector operation unit's output. Each memory block may be coupled with a compute unit through a via.

### CROSS-REFERENCE TO RELATED APPLICATION

This application claims the benefit of U.S. Provisional Patent Application No. 63/754,808, filed Feb. 6, 2025, and titled “WAFER-LEVEL DISTRIBUTED INTEGRATED MEMORY AND COMPUTE FOR OPTIMIZED TRANSFORMER MODEL COMPUTATION,” which is incorporated by reference in its entirety for all purposes.

### TECHNICAL FIELD

This disclosure relates generally to artificial intelligence (AI), and more specifically, integrated memory and compute systems for optimized neural network computations, such as transformer model computations.

### BACKGROUND

Neural networks (also referred to as “deep neural networks” or “DNNs”) are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an integrated circuit (IC) device that implements a model on silicon, in accordance with various embodiments.

FIG. 2 illustrates an inference process of a DNN model, in accordance with various embodiments.

FIG. 3 illustrates an integrated system for optimized DNN computations, in accordance with various embodiments.

FIG. 4 illustrates an integrated cell, in accordance with various embodiments.

FIG. 5 illustrates a perspective view of a three-dimensional (3D) integrated system, in accordance with various embodiments.

FIG. 6 illustrates interconnect and fabric integration within an integrated system, in accordance with various embodiments.

FIG. 7 illustrates a layout of a multiply-add unit, in accordance with various embodiments.

FIG. 8 illustrates an embedding dot unit, in accordance with various embodiments.

FIG. 9 illustrates a sequential read-only memory (ROM), in accordance with various embodiments.

FIG. 10 illustrates an attention multiplier unit, in accordance with various embodiments.

FIG. 11 is a flowchart showing a method of executing a DNN model, in accordance with various embodiments.

FIG. 12 illustrates an example transformer model, in accordance with various embodiments.

FIG. 13 illustrates the first inference process of a transformer model, in accordance with various embodiments.

FIG. 14 illustrates subsequent inference processes of the transformer model in FIG. 13, in accordance with various embodiments.

FIG. 15 is a block diagram of an example computing device, in accordance with various embodiments.

### DETAILED DESCRIPTION

The last decade has witnessed a rapid rise in AI based data processing, particularly based on DNNs. DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., Sigmoid linear unit (SiLU) operation, SoftMax operation, etc.), pooling, elementwise operation, linear operation, nonlinear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a two-dimensional (2D) weight tensor), a filter (a 3D weight tensor), or a group of filters (a four-dimensional (4D) weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is 2D tensor), 3D tensors, 4D tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Deployment and execution of many complex DNN models can be carried out on high-performance graphics processing units (GPUs). While GPUs can provide the computational horsepower needed to handle these sophisticated models, they come with significant drawbacks, including high power consumption and latency issues. These limitations become especially problematic in environments where real-time processing and power efficiency are critical, such as in mobile devices, edge computing, and Internet of Things (IoT) applications.

Current methodologies often employ sequential ROMs in key multiply-add operational implementations, leading to flexibility issues. ROMs are typically static and lack the adaptability required for the dynamic workloads encountered in AI and machine learning tasks. This rigidity can result in inefficiencies and limit the system's ability to optimize performance for varying computational demands. A currently available methodology employed in the chip design involves using separate sequential ROMs that hold the data, alongside distinct multipliers and tree adders that processed this data. However, this approach necessitates considerable routing between sequential ROMs, multipliers, and adders, as well as other parts of the logic fabric. Consequently, this can lead to inefficiencies due to the significant routing overhead and the latency introduced by the interconnections. Moreover, the design's flexibility can be compromised as it was tailored to specific models, making it less adaptable for various AI models and applications. The lack of flexibility can pose a significant challenge in optimizing performance across diverse AI workloads, ultimately impacting the system's overall efficiency and capability to handle varying model sizes and complexities.

Some currently available solutions are based on GPUs. The customary method typically involves using a standard GPU. In this setup, model weights are loaded from memory every time an inference task is undertaken. While GPUs can provide versatility, capable of managing a broad spectrum of tasks, this flexibility results in compromises in areas like optimization, power consumption, and latency. Specifically, general-purpose GPUs, despite having stacked memory, do not perform computations within the memory. Consequently, data frequently shuttle between the memory and the GPU compute units, leading to high-bandwidth transactions. This process is power-intensive and time-consuming, especially for complex models. Furthermore, the design of GPUs to handle a variety of tasks makes them inefficient for dedicated tasks such as inference on a pretrained model.

There are also compute-in-memory solutions. This approach typically combines memory and processing units within a single chip, allowing computations to be performed directly where the data resides. This architecture can minimize the need for data transfer between memory and processing units, which can greatly reduce energy consumption and latency. Additionally, compute-in-memory solutions can offer substantial improvements in data throughput, making them highly suitable for real-time AI applications and edge computing. Despite the advantages, compute-in-memory solutions often face challenges in scalability and flexibility. The dense integration of memory and compute units can complicate the design and manufacturing process, leading to higher costs and potential reliability issues. Furthermore, heat dissipation can be a significant concern, as the proximity of computational and memory units can lead to thermal management problems, impacting the overall performance and longevity of the system.

There are also memory-in-compute solutions. This approach typically integrates memory and processing units to perform computations directly where data is stored. This can eliminate the need for extensive data movement between memory and processing units, theoretically reducing latency and energy consumption. Although memory-in-compute solutions can significantly enhance data throughput and reduce latency, they often suffer from limited scalability and flexibility. The integration of memory with compute units complicates the design and manufacturing process, leading to higher costs and potential reliability issues. Furthermore, these solutions may struggle with heat dissipation due to the dense packing of computational and memory units, which can impact overall performance and longevity.

There are also solutions based on neural processing units (NPUs). NPUs are typically specialized hardware designed explicitly for AI tasks, particularly inference on pretrained models. They are optimized for the types of computations required in deep learning, such as matrix multiplications and convolutions, and can handle large-scale model weights more efficiently than general-purpose hardware. NPUs, similar to GPUs, can provide flexibility for deep learning tasks. However, this flexibility can come at the expense of limitation in the model size and context input.

Central processing units (CPUs) are also used for AI inference tasks. By loading the model on them. CPUs are not suitable for large-scale matrix multiplications which are essential for AI inferencing tasks. They also consume more power and are slower in comparison to dedicated solutions.

There are also solutions based on dedicated accelerators. Dedicated accelerators are typically designed specifically for AI training and inference tasks. These accelerators can offer high performance and efficiency for specific AI workloads by optimizing hardware for the unique demands of deep learning computations. They can handle large-scale models and complex operations more effectively than general-purpose hardware. While dedicated accelerators provide unparalleled performance for AI tasks, they usually still require frequent data movement between memory and processing units, which can introduce latency and reduce overall efficiency. This need for data transfer can limit their effectiveness for tasks that require rapid and extensive memory access.

Some solutions are based on AI processors. These processors can significantly outperform traditional edge AI processors in terms of area and power efficiency. Utilizing a unique, powerful, and scalable structure-driven dataflow architecture, AI processors can take advantage of the core properties of DNNs. This can enable edge devices to run deep learning applications at full scale more efficiently, effectively, and substantially than traditional solutions, while significantly lowering costs. Despite their impressive performance and efficiency, many AI processors are optimized for very small models and are not efficient for larger models where data needs to move back and forth from memory, impacting overall performance and efficiency. And they are still not real-time.

Field Programmable Gate Arrays (FPGAs) are another solution used for AI inference. They are programmable hardware that can be customized to perform specific tasks, including loading and handling large language model (LLM) weights. While FPGAs offer flexibility, they may have significantly lower performance compared to dedicated hardware solutions and may not be as power efficient or cost effective.

Embodiments of this disclosure may improve on at least some of the challenges and issues described above providing an integrated compute and memory system that can accelerate operations in DNNs, including transformer models. In an example, the model architecture and weights of a DNN model are embedded on an IC device. The IC device may be a 3D integrated system including a memory die stacked over a logic die. By co-locating memory and compute within a single 3D structure, this design can significantly reduce data transfer latencies and power consumption, resulting in faster, more efficient computations for advanced DNN models.

In various embodiments of this disclosure, a 3D integrated system may implement inference of a DNN model, such as inference of a transformer model. The 3D integrated system may include a memory die, a logic die, and vias arranged between the memory die and logic die. A via may be a through-silicon via (TSV). The memory die may include memory blocks, such as dynamic random-access memory (DRAM) blocks. The logic die may include an interface unit, a vector operation unit, compute units (e.g., multiply-accumulate units), and an interconnect fabric with adders. The interface unit may receive the input of the DNN model and send out output of the DNN. The interface unit may include a PCIe unit. The interface unit may also include a flow control unit that can orchestrate operations of the other components of the 3D integrated system based on a timing sequence of the DNN model. The vector operation unit may perform one or more vector operations of the DNN based on the input. An example of the input may be an input prompt from a user. The vector operation unit may include registers, such as vector registers or scalar registers. Data may be transferred between the registers and the memory die through the interconnect fabric. The compute units and adders may perform matrix multiplication operations of the DNN based on the vector operation unit's output. A compute unit may be coupled to a memory block through a via. For instance, an end of the via may be connected to the compute unit, and the other end of the via may be connected to the memory block. The memory block may store data processed or generated by the compute unit. The adders on the interconnect fabric may be arranged in a sequence. In an example, the first adder may receive data points computed by two or more compute units and compute a sum of the data points. The sum may be transferred to a second adder for further summation through the interconnect fabric.

This disclosure provides a dedicated, real-time, efficient, and cost-effective solution for machine learning inference. An advantage of the approach in this disclosure is flexibility. Using DRAM instead of ROM within the integrated system can provide much better flexibility. Unlike ROM, which is fixed and cannot be modified after manufacturing, DRAM allows for dynamic data storage and retrieval, providing the ability to adapt to different computational tasks and model requirements. This flexibility can be crucial for applications involving LLMs, which often require frequent updates and adjustments to the stored data. Despite being within the same die, the use of DRAM can ensure that there is no memory wall, as the high-bandwidth, low-latency connections facilitated by the TSVs maintain efficient data transfer between memory and compute units. This can result in a system that is both versatile and efficient, capable of meeting the demands of sophisticated deep learning models.

Another advantage of the approach in this disclosure is scalability. One of the significant challenges in deploying efficient computation models is the physical space constraints and routing complexities on a silicon chip. This disclosure addresses this by wafer bonding DRAM directly on top of a logic wafer, creating a vertically integrated chip stack. Each stack may include high-density memory on the top and specialized compute logic on the bottom, connected by TSVs. This 3D integration can eliminate the need for extensive routing between separate components, thereby saving space and reducing data movement. The modular nature of the chip stacks can allow for scalable and flexible deployment, adapting to various computational needs and future technological advancements. By co-locating memory and compute within a single structure, the design can optimize performance and efficiency, making it ideal for accelerating operations in LLMs such as transformers.

Yet another advantage of this approach is real-time computing. The power efficiency and performance improvements provided by the approach in this disclosure can make it ideal for edge computing, mobile, and IoT applications where resources are limited and low latency is crucial. By integrating memory and compute logic within a single 3D structure, this approach can eliminate the need for extensive routing and significantly reduce data movement. This tightly integrated design can support real-time computing requirements more effectively, ensuring rapid and efficient processing of computational tasks. As a result, this approach is highly suitable for time-sensitive applications, delivering quick and reliable performance in resource-constrained environments

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

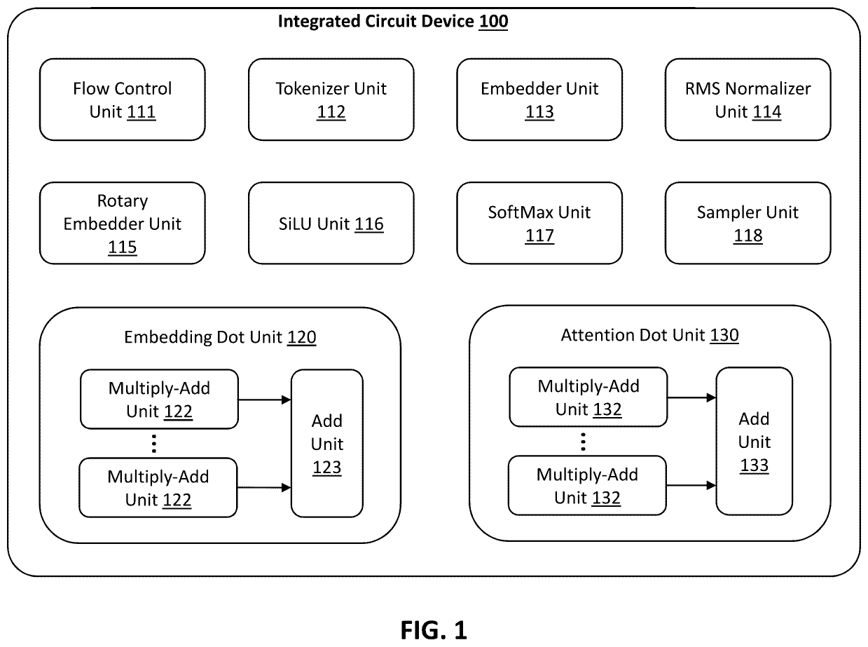

FIG. 1 illustrates an IC device 100 that implements a model on silicon, in accordance with various embodiments. In some embodiments, the IC device 100 may be a hardware implementation of a DNN, such as a transformer-based model. An example of the DNN is an LLM. At least part of the model architecture, weights, and flow of the DNN can be embedded into the IC device 100. For instance, the IC device 100 may include memories that store the weights of the DNN. The IC device 100 may also include compute units that are mapped to the operators in the DNN. In some embodiments, the IC device 100 may be a chip, such as a silicon chip.

As shown in FIG. 1, the IC device 100 includes a flow control unit 111, tokenizer unit 112, embedder unit 113, root mean square (RMS) normalizer unit 114, rotary embedder unit 115, SiLU unit 116, SoftMax unit 117, sampler unit 118, embedding dot unit 120, and attention dot unit 130. A unit in the IC device 100 may be a circuit or may include multiple circuits. In other embodiments, the IC device 100 may include fewer, more, or different components. For example, the IC device 100 may include more than one flow control unit 111, tokenizer unit 112, embedder unit 113, RMS normalizer unit 114, rotary embedder unit 115, SiLU unit 116, SoftMax unit 117, sampler unit 118, embedding dot unit 120, or attention dot unit 130. As another example, the units may be arranged in fewer, more, or different dies of the IC device 100. Further, functionality attributed to a component of IC device 100 may be accomplished by a different component included in the IC device 100 or a different device.

The flow control unit 111 manages data flow between various components of the IC device 100. In some embodiments, the flow control unit 111 plays a role in orchestrating various components (e.g., units) of the IC device 100 to execute operations according to a predetermined timing sequence. The flow control unit 111 may also be referred to as a sequencer unit, which can orchestrate one or more other components of the IC device 100 according to a predetermined timing sequence of the DNN. In an example, the flow control unit 111 may control and ensure that the tokenizer unit 112 converts input tokens and passes them to the embedding sections, such as the embedder unit 113, the rotary embedder unit 115, and embedding dot unit 120; the embeddings are then processed and passed to the attention dot unit 130 for attention computation; the attention results are then normalized by the RMS normalizer unit 114, activated by the SiLU unit 116, and passed through the SoftMax unit 117 to generate output probabilities; finally, the sampler unit 118 samples from the output distribution and generates the final output tokens.

In some embodiments, the DNN operates in a feedforward manner. In an example, the DNN may include a sequence of layers. A layer may have one or more operators. For a layer having multiple operators, the operators may be arranged in the sequence. Each operator may correspond to a neural network operation. For example, a MatMul operator specifies a MatMul operation. The sequence of all the operators in the DNN may be predetermined as a part of the model architecture of the DNN. In some embodiments, the spatial shape of the input tensor(s) and output tensor of an operator can also be predetermined. During inference, data flows through the operators in the DNN in the predetermined sequence. The predetermined sequence of the operators in the DNN can be mapped into a timing sequence of various components of the IC device 100 executing the corresponding neural network operations. The timing sequence of neural network operations may include stages of operations, one following another. In a particular time slot or stage in the timing sequence, data can be moved in, processed, and moved out to be processed in the next/following time slot, in a feedforward, progressive manner.

In some embodiments, the flow control unit 111 may implement digital logic to generate clock edges/signals (e.g., control signals, timing signals, enable signals, disable signals, trigger signals, etc.) to orchestrate operations to be performed according to the timing sequence. The flow control unit 111 may control data flow into or out of one or more other components of the IC device 100. The flow control unit 111 may also enable or disable one or more other components of the IC device 100 according to a predetermined timing sequence.

The tokenizer unit 112 is a hardware implementation of a tokenizer in the DNN. In an example, the tokenizer unit 112 is a hardware-based tokenizer for a DNN. The tokenizer unit 112 may convert raw data (e.g., words) to tokens. For instance, the tokenizer unit 112 may use the DNN's vocabulary to convert works received from a user to tokens that can be further processed by other operators in the DNN. The vocabulary may be predefined vocabulary. In some embodiments, the vocabulary of the DNN is implemented on the tokenizer unit 112. For instance, the vocabulary may be stored in a data storage unit of the tokenizer unit 112. The tokenizer unit 112, after receiving words, may compare the words with the vocabulary to determine indices of tokens corresponding to the words. The tokenizer unit 112 may output the token indices.

In some embodiments, the tokenizer unit 112 includes a cycle buffer, comparator, memory, ID block, and multiplexer (MUX). The cycle buffer may receive and store data received by the tokenizer unit 112. The data may be the input data of the DNN. The input data may be one or more words that need to be tokenized. In some embodiments, the tokenizer unit 112 may have a different type of data storage unit from the cycle buffer for storing input data. The comparator retrieves input data from the cycle buffer and compares the word(s) with the vocabulary of the DNN. The vocabulary of the DNN is stored in the memory. The memory may be a ROM, such as a sequential ROM. The memory may store a list of vocabulary entries, which are predefined words or tokens. Each vocabulary entry corresponds to a unique Token ID. The ID block stores the Token IDs associated with each vocabulary entry. When the comparator finds a match in the vocabulary, the ID block receives the corresponding Token ID. After a Token ID is retrieved, it is output through the ID block. The comparator may access the vocabulary in the memory to find a match for each word in the input data. When a match is found, the corresponding Token ID is fetched from the ID block and provided to the MUX. The MUX may output the Token ID as an output of the tokenizer unit 112. In some embodiments, the output of the Token ID from the MUX may be controlled by a signal from the comparator. The signal may indicate that a match has been found.

The embedder unit 113 may implement an embedder (e.g., an embedding layer) of the DNN. The embedder unit 113 may execute the embedding layer to convert tokens (such as tokens generated by and received from the tokenizer unit 112) to embedding vectors. In some embodiments, the embedder unit 113 may include look-up tables that map tokens to embedding elements. The look-up tables may output embedding elements corresponding to input tokens. The embedding elements may constitute the embedding vector of the input tokens.

In an example, the embedder unit 113 includes 256 look-up tables. The look-up tables may have the same storage size, e.g., 1000 KB. Each of the look-up tables may have 112,000 lines. In some embodiments, the look-up tables may be implemented on one or more ROMs. In an example, the 256 look-up tables are implemented on 256 ROMs, respectively. The embedder unit 113 may receive an input token. In the example shown in FIG. 1, the embedder unit 113 receives an input token represented by 15 bits. The input token may have an integer format. The embedder unit 113 may also receive control signals. For instance, the embedder unit 113 receives an embedder cycle signal, which may have 10 bits. The embedder unit 113 also receives an embedder run signal, which may have 1 bit. The embedder unit 113 may also receive an embedder on/off signal, which may have 1 bit.

The output of the embedder unit 113 may be an embedding vector. For instance, the embedder unit 113 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 113 may receive 32,000 tokens. The total embedder size may be 250 MB, which equals 10, 096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. Within each cycle, the 256 look-up tables may output 256 embedding vector elements, respectively. The embedder unit 113 may return 256 elements every clock cycle for 16 clocks cycles. After finishing the 16 cycles, the embedder unit 113 may be idle for about 10,000 cycles. Power gating may be used.

The RMS normalizer unit 114 may normalize data using RMS normalization. The RMS normalizer unit 114 may implement one or more RMS normalizer functions in the DNN. An RMS normalizer function may be denoted as:

$$\frac{{x}_{i} \cdot {W}_{R M {S}_{i}}}{\sqrt{\frac{{\sum }_{j = 0}^{4 , 096} {x}_{j}^{2}}{4 , 096} + 1 {0}^{- 5}}}$$

In some embodiments, the RMS normalizer unit 114 may receive an input vector (e.g., 4096 FP16 elements) and return an RMS-normalized vector (e.g., 4096 elements in FP8 format). The RMS normalizer unit 114 may receive 256 elements every clock for 16 clocks cycles. The RMS normalizer unit 114 may include tree adder 1502 to add a number of values (e.g., 256 values) together simultaneously. The RMS normalizer unit 114 may include ROM 1504 storing a look-up table comprising one or more precomputed values of the function:

$$f ( x ) = {\sqrt{\frac{x}{4 , 096} + 1 {0}^{- 5}}}^{- 1} .$$

The rotary embedder unit 115 may apply rotary positional embeddings on input data. The rotary embedder unit 115 is the hardware implementation of one or more rotary position encoders in the DNN. The rotary embedder unit 115 may produce rotary positional encoded embeddings. In some embodiments, the rotary embedder unit 115 may provide the functionality of a sine cosine unit without the need to calculate/compute sine and cosine in real-time. The rotary embedder unit 115 may have a sine cosine unit that has a look-up table implementation. In some embodiments, the rotary embedder unit 115 may include a look-up table comprising one or more precomputed values of a cosine function

$$( e . g . , f ( t ) = cos ( {10}^{- \frac{{h}_{n}}{16}} \cdot t ) ) .$$

The rotary embedder unit 115 may include another look-up table comprising one or more precomputed values of sine function

$$( e . g . , f ( t ) = sin ( {10}^{- \frac{{h}_{n}}{16}} \cdot t ) ) .$$

The SiLU unit 116 is a hardware implementation of one or more SiLU activators in the DNN. The SiLU unit 116 may include a look-up table having one or more precomputed values of a SiLU function:

$$f ( x ) = \frac{x}{1 + {e}^{- x}}$$

In some cases, the SiLU unit 116 includes a MUX controller and a MUX. The MUX controller may check whether the input value meets a particular condition and selects a particular value to use as the output of SiLU unit 116. The MUX controller may output a 2-bit value as selection signal for the MUX, to select one of three possible values to use as the output. For example, when the sign bit is 0 and the most-significant bits (MSBs) of the input are “11”, the input is selected by the MUX and passed on to use as the output. When the sign bit is 1 and the MSBs of the input are “11”, the value of “0” is selected by the MUX to use as the output. Otherwise, the value from the look-up table is used as the output.

The SoftMax unit 117 is a hardware implementation of one or more SoftMax activators in the DNN. The SoftMax unit 117 may implement a SoftMax function for output probability distribution. In some embodiments, the SoftMax unit 117 may execute a SoftMax function using one or more look-up tables that are pre-configured with precomputed data. The SoftMax function may be:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

In some embodiments, the SoftMax unit 117 includes look-up table implementation of the SoftMax function instead of a compute-oriented solution. In some embodiments, the SoftMax unit 117 receives an input vector of t FP16 elements (1<t<512) and returns the SoftMax normalized vector of the same size. The SoftMax unit 117 receives 16 numbers per cycle for up to 32 cycles and returns 16 numbers per cycle for up to 32 cycles.

In an example, the SoftMax unit 117 receives an input vector including 16 elements, each of which is a FP16 value, in a clock cycle. The total number of bits of the input vector is 256. The SoftMax unit 117 may also receive a compare control signal, normalize control signal, exponent control signal, multiply control signal, on/off control signal, other types of control signals, or some combination thereof. A control signal may have 1 bit. The output of the SoftMax unit 117 may be 16 elements with UFP16 format. The total number bits may be 240. The SoftMax unit 117 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 117 may be included in the attention dot unit 131 to perform SoftMax on an input vector (e.g., FP16 vector) and to output a SoftMax-ed vector (e.g., FP16 vector). The SoftMax unit 117 may include a look-up table comprising one or more precomputed values of an exponent function:

$$f ( x ) = {e}^{\frac{x}{\sqrt{128}}} .$$

The SoftMax unit 117 may include another look-up table comprising one or more precomputed values of a reciprocal function:

$$f ( x ) = \frac{1}{x} .$$

The SoftMax unit 117 may include a tree adder that can add a number of values (e.g., 18 values) together simultaneously.

The sampler unit 118 is a hardware implementation of one or more samplers in the DNN. The sampler unit 118 may sample from the output distribution. In some embodiments, the sampler unit 118 may receive an input vector and compare elements of the input vector to find the largest value. The sampler unit 118 may determine the index of the largest number and return a token. In some embodiments, the sampler unit 118 may receive a logits vector. In an example, the vector may include 32,000 elements. In some embodiments, the sampler unit 118 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 118 may implement a deterministic sampler having zero temperature. The sampler unit 118 may also receive control signals, such as an on/off signal indicating whether the sampler unit 118 is to be on or off, a restart signal indicating whether to restart the sampler unit 118, and a run signal. A control signal may have 1 bit. The sampler unit 118 may determine an index, such as a 32-bit index, corresponding to the largest number in the input vector. The index may correspond to an output token. In some embodiments, the output token may be a 15-bit integer.

In some embodiments, the sampler unit 118 includes 256 sampling comparators. In other embodiments, the sampler unit 118 may include a different number of sampling comparators. With the 256 sampling comparators, the sampler unit 118 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 118 may return the token with the lowest index out of the equal tokens. When finishing the 125 clock cycles, the sampler unit 118 returns the token of the largest value in the input vector. For instance, the sampler unit 118 may output the index of the largest value in the input vector.

In some embodiments, the sampler unit 118 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 118 may have a latency of 9 clock cycles. Every layer of comparators may be pipeline. In some embodiments, the sampler unit 118 may have power gating.

The embedding dot unit 120 is hardware implementation of embedding computations in the DNN. For instance, the embedding dot unit 120 may implement MatMul operators and add operators in the DNN, such as the MatMul operators and add operators in one or more encoders of the DNN. The embedding dot unit 120 may handle the initial embedding of tokens, performing matrix multiplications to transform input data into a suitable format for the DNN. The embedding dot unit 120 may convert input tokens into dense vector representations, which may be essential for subsequent processing in the DNN. In some embodiments, the embedding dot unit 120 are compute-in-memory units, which hold the static weights of the DNN. The static weights may be weights that do not change during inference of the DNN. The embedding dot unit 121 includes a plurality of multiply-add units 122 (individually referred to as “multiply-add unit 122”) and an add unit 123.

In some embodiments, the multiply-add units 122 may perform MatMul operations. A MatMul operation may be performed on a weight tensor and an activation tensor. The activation tensor may be the output of the previous operators in the DNN. Weight tensors may be stored in memory blocks associated with the multiply-add units 122. In some embodiments, the multiply-add units 122 may be associated with ROMs. Weight tensors used by the multiply-add units 122 may be stored in ROM blocks. The ROM blocks may be sequential ROM blocks. Sequence ROM is a type of memory storage, utilizing ROMs, that allows data to be read sequentially but not written or modified after the values have been etched onto the ROM. The rest of the ROM can be shut down to reduce power and area. This ROM-based design can ensure efficient storage and quick access to static weights, enhancing the speed and efficiency of embedding operations.

The attention dot unit 130 is hardware implementation of attention computations in the DNN. For instance, the attention dot unit 130 may implement MatMul operators and add operators in the DNN, such as the MatMul operators and add operators in one or more decoders of the DNN. The attention mechanism may be critical for understanding the relationships between different parts of the input sequence. The attention dot unit 130 may focus on the computation of attention scores and the weighted sum of value vectors, which may be critical for capturing dependencies and relationships between different parts of the input data. The attention dot unit 130 may be compute-in-memory dies. The attention dot unit 130 may utilize sequential RAM to handle the dynamic nature of attention computations. This sequential RAM-based design can allow for fast and efficient computation of attention scores, leveraging high memory bandwidth and low latency to optimize performance.

As shown in FIG. 1, the attention dot unit 131 includes a plurality of multiply-add units 132 (individually referred to as “multiply-add unit 132”) and an add unit 133. In some embodiments, each multiply-add unit 132 may include one or more multipliers and tree adders. In one implementation, a multiply-add unit 132 may carry out a (128-elements) dot product operation between FP16 input vector and FP16 K or V vector cached in one or more memory blocks, e.g., every cycle. The dot product operation can be performed using the one or more multipliers and one or more tree adders in the multiply-add unit 132. A multiplier may multiple two values, such as two floating-point values. In an example, the attention dot unit 131 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 131 may receive data from one or more memory blocks. One or more tree adders may add multiplication results produced by one or more multipliers together.

The memory blocks can store and provide data to one or more circuits performing logic operations in the multiply-add units 132. In some embodiments, a multiply-add unit 132 may receive an input number and multiplies it by a number from the corresponding memory block in every clock cycle. The memory blocks may be RAM blocks, such as DRAM blocks. In some embodiments, a RAM may be a sequential read/write memory, such as a sequential read/write static random-access memory (SRAM). A sequential read/write memory can be used with or in an attention dot unit to supply weights to a multiplier in the multiply-add unit 132. A RAM that can be read sequentially or written sequentially may have drastically simplified logic and circuitry for reads or writes. The RAM may be used in a special configuration where it is not dynamically readable but is built up sequentially to reduce power and area.

In some embodiments, a RAM of a multiply-add unit 132 may be placed in proximity to the circuits performing logic operations in the multiply-add unit 132. The RAM may store intermediate values of the DNN. The intermediate values may be dynamic during the DNN inference, meaning their values may change. For instance, the RAM may store a key-value (KV) cache. New keys or values may be written into the RAM as they are generated. The RAM may be referred to as KV RAM. In embodiments where the RAM is a SRAM, it may be referred to as a KV SRAM. KV RAM can enable storing the attention history (e.g., cached keys and values) of a transformer block. In an exemplary implementation, 64 SRAMs may be used to store the 32 layers and K vs. V separately, so the SRAM can read lines sequentially. The tree adders in the multiply-add units 132 may add multiplication results produced by the multipliers together. A tree adder may also be referred to as an adder tree and may include adders arranged in a tree structure. The add unit 133 may add outputs of the multiply-add units 132.

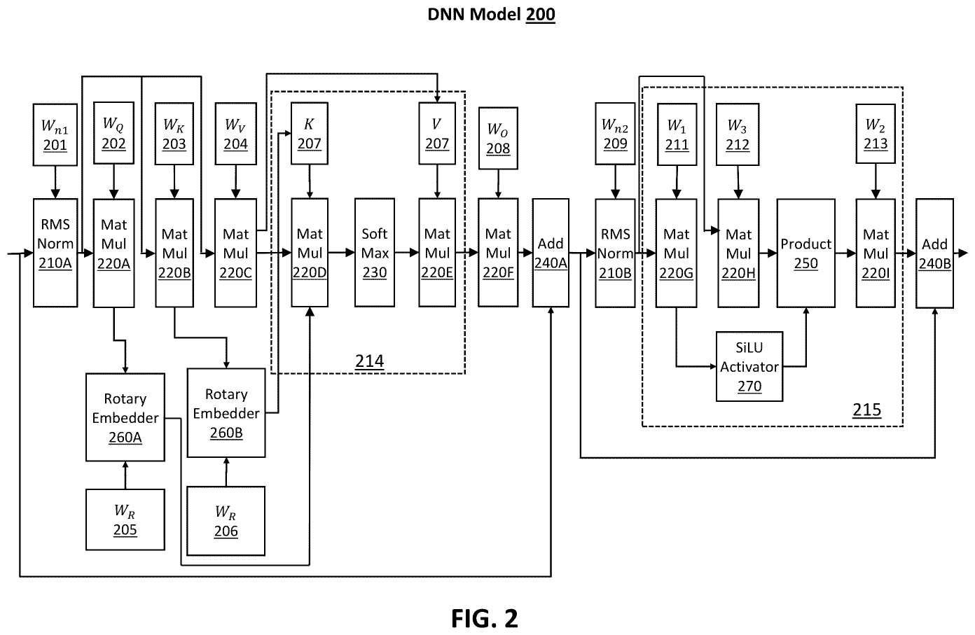

FIG. 2 illustrates an inference process of a DNN model 200, in accordance with various embodiments. In the embodiment of FIG. 2, the DNN model 200 is a transformer-based model. For instance, the DNN model 200 may be LLM, speech recognition model, and so on. The DNN model 200 may process input embeddings through a series of highly optimized neural network operations to generate output. The DNN model 200 may be embedded on an IC device, such as the IC device 100 in FIG. 1. For instance, the weights of the DNN model 200 may be stored in memories of the IC device 100, and operators in the DNN model 200 may be mapped to compute units of the IC device 100.

As shown in FIG. 2, the DNN model 200 includes RMS normalizers 210A and 210B, MatMul operators 220A-220I, SoftMax activator 230, add operators 240A and 240B, product operator 250, rotary embedders 260A and 260B, and SiLU activator 270. These operators are arranged in a sequence as shown in FIG. 2. The sequence may indicate a timing sequence of the operators during the inference process. For the purpose of illustration, RMS normalizer is shown as “RMS norm” in FIG. 2, MatMul operator is shown as “MatMul” in FIG. 2, SoftMax activator is shown as “SoftMax” in FIG. 2, add operator is shown as “add” in FIG. 2, and product operator is shown as “product” in FIG. 2. In other embodiments, the DNN model 200 may include fewer, more, or different components. Also, the arrangement of the components in the DNN model 200 may be different.

The RMS normalizer 210A can standardize input data, such as input embeddings. The RMS normalizer 210A may perform an RMS normalization on an input to the DNN model 200 using a weight vector 201. In an example, the spatial size of the weight vector 201 may be 4, meaning the weight vector 201 includes 4 data elements in it. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 201 may also denoted as Wₙ₁. The RMS normalization can normalize input data elements of the DNN model 200 based on the RMS of the activations. The normalization may stabilize the inputs and ensure that the attention weights can be computed on approximately scaled inputs, leading to better training stability and faster convergence. The output of the RMS normalizer 210A may be one or more tokens. In an example, the token may be represented by a 15-bit integer. The output of the RMS normalizer 210A is a vector. In an example, the dimension of the vector is 4.

At least some of the MatMul operators 220A-220F can handle the transformation and integration of embedding vectors across different layers. As shown in FIG. 2, the output of the RMS normalizer 210A is provided to the MatMul operator 220A. The MatMul operator 220A performs MatMul on the output of the RMS normalizer 210A and a weight matrix 202. The weight matrix 202 may be a matrix of query weights, which may be denoted as W_{Q}. The MatMul result is provided to the MatMul operator 220B. The output of the RMS normalizer 210A is also provided to the MatMul operator 220B. The MatMul operator 220B performs MatMul on the output of the RMS normalizer 210A and a weight matrix 203. The weight matrix 203 may be a matrix of key weights, which may be denoted as W_{K}. The output of the RMS normalizer 210A is also provided to the MatMul operator 220C. The MatMul operator 220C performs MatMul on the output of the RMS normalizer 210A and a weight matrix 204. The weight matrix 204 may be a matrix of value weights, which may be denoted as Wy. The MatMul result of the MatMul operator 220A, MatMul operator 220B, or MatMul operator 220C may be a vector. In an example, the spatial size of the weight matrix 202, weight matrix 203, or weight matrix 204 is 4×4; and the dimension of the vector computed by the MatMul operator 220A, MatMul operator 220B, or MatMul operator 220C is 4.

The MatMul result computed by the MatMul operator 220A is provided to the rotary embedder 260A. The rotary embedder 260A may apply a weight matrix 205 on input data. The weight matrix 205 is represented by W_{R} in FIG. 2. The rotary embedder 260A may produce rotary positional encoded embeddings. In some embodiments, the operation of the rotary embedder 260A may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220A, and w is weight. In an example, the dimension of the weight matrix 205 is 128×512.

The MatMul result computed by the MatMul operator 220B is provided to the rotary embedder 260B. The rotary embedder 260B may apply a weight matrix 206 on input data. The weight matrix 206 is represented by W_{R} in FIG. 2. The rotary embedder 260B may produce rotary positional encoded embeddings. In some embodiments, the operation of the rotary embedder 260B may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220B, and w is weight. In an example, the dimension of the weight matrix 206 is 128×512.

The output of the rotary embedder 260A or rotary embedder 260B may be a vector. In an example, the dimension of the vector is 4. The output of the rotary embedder 260A is provided to the MatMul operator 220D. The MatMul operator 220D also receives keys from a KV cache 207. The cache 207 receives keys from the rotary embedder 260B. the MatMul operator 220D may perform a MatMul operation on the keys and the output of the rotary embedder 260A to compute a vector. In an example, the keys may be in a matrix, e.g., a matrix with a dimension of 2×<1024, in which <1024 may be a timestamp dimension T; the data received from the rotary embedder 260A may be a vector with a dimension of 2; and the output of the MatMul operator 220D may be a vector with a dimension of <1024.

The output of the MatMul operator 220D is provided to the SoftMax activator 230. The SoftMax activator 230 may apply a SoftMax function on the output of the MatMul operator 220D. The SoftMax function may be denoted as

$$\frac{{e}^{\frac{{x}_{i} - {x}_{max}}{\sqrt{64}}}}{{\sum }_{j = 0}^{t} {e}^{\frac{{x}_{j} - {x}_{max}}{\sqrt{64}}}} .$$

In an example, the output of the SoftMax activator 230 may be a vector with a dimension of <1024.

The output of the SoftMax activator 230 is provided to the MatMul operator 220E. The MatMul operator 220E also receives values from the cache 207. In some embodiments, at least some of the values are computed by the rotary embedder 260B. In an example, the values may be in a matrix, e.g., a matrix with a dimension of <1024×2, in which <1024 may be a timestamp dimension T; and the output of the MatMul operator 220E may be a vector with a dimension of 2. In some embodiments, T=1 for the first token. The context size may be denoted as Max T. In some embodiments, the MatMul operator 220D, SoftMax activator 230, and MatMul operator 220E may constitute a multi-headed attention block 214. In some embodiments, the DNN model 200 may include a plurality of multi-headed attention blocks 214 that can run in parallel. For instance, two embedding vectors may be split to two heads sized 2. The multi-headed attention block 214 may be a multi-headed attention layer.

The output of the MatMul operator 220E is input into the MatMul operator 220F. The MatMul operator 220F also receives a weight matrix 208. The weight matrix 208 is shown as W_{O} in FIG. 2. In an example, the dimensions of the weight matrix 208 is 4×4. The data received by the MatMul operator 220F from the MatMul operator 220E may be a vector, whose dimension may be 4. The output of the MatMul operator 220F may be a vector, whose dimension may be 4.

The output of the MatMul operator 220F is provided to the add operator 240A. The operators 240A may perform an elementwise addition on the output of the MatMul operator 220F and the input to the RMS normalizer 210. In some embodiments, the elementwise addition is denoted as f(x, y)=x+y. In an example, the two inputs to the operators 240A may each be a vector with a dimension of 4, and the output of the operators 240B may also be a vector with a dimension of 4.

The output of the operators 240A is provided to the RMS normalizer 210B. The RMS normalizer 210B can standardize data it receives. The RMS normalizer 210B may perform an RMS normalization on the output of the operators 240A using a weight vector 209. In an example, the spatial size of the weight vector 201 may be 4. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 209 may also denoted as Wₙ₂. The RMS normalization can normalize data elements based on the RMS of the data elements. The normalization may stabilize the inputs and ensure that the attention weights can be computed on approximately scaled inputs, leading to better training stability and faster convergence. The output of the RMS normalizer 210B may be one or more tokens. In an example, the token may be represented by a 15-bit integer. In some embodiments, the output of the RMS normalizer 210B is a vector. In an example, the dimension of the vector is 4.

The output of the RMS normalizer 210B is provided to the MatMul operator 220G. The MatMul operator 220G also receives a weight matrix 211. The weight matrix 211 is shown as W₁ in FIG. 2. In an embodiment, the spatial shape of the weight matrix 211 is 4×10, the dimension of the output of the RMS normalizer 210B is 4, and the dimension of the output of the 220G is 10. The output of the MatMul operator 220G is provided to the SiLU activator 270. The SiLU activator 270 may apply a SiLU function on the output of the MatMul operator 220G. The SiLU activator 270 may perform the SiLU operation in an elementwise manner, meaning for every data element input into the SiLU activator 270, the SiLU activator 270 applies the SiLU function and computes an output data element. In an example, the input to the SiLU activator 270 is a vector including 10 data elements, and the output of the SiLU activator 270 is also a vector including 10 data elements.

The output of the RMS normalizer 210B is also provided to the MatMul operator 220H. The MatMul operator 220H also receives a weight matrix 212. The weight matrix 212 is shown as W₃ in FIG. 2. In an embodiment, the spatial shape of the weight matrix 212 is 4×10, the dimension of the output of the RMS normalizer 210B is 4, and the dimension of the output of the 220H is 10.

The output of the MatMul operator 220H is provided to the product operator 250. The product operator 250 also receives the output of the SiLU activator 270. The product operator 250 may perform an elementwise multiplication on the two inputs. The elementwise multiplication may be denoted as f(x, y)=x·y. In some embodiments, the two inputs are each a vector including 10 data elements, and the output of the product operator 250 is also a vector including 10 data elements.

The output of the product operator 250 is provided to the MatMul operator 220I. The MatMul operator 220I also receives a weight matrix 213. The weight matrix 213 is shown as W₂ in FIG. 2. In an embodiment, the spatial shape of the weight matrix 213 is 10×4, the dimension of the output of the product operator 250 is 10, and the dimension of the output of the 220I is 4. In some embodiments, the MatMul operator 220G, 220H, product operator 250, and MatMul operator 220I may constitute a feed forward neural network 215. The 215 may be denoted as W₂(Silu(W₁(x))×W₃(x)). The feed forward neural network 215 can ensure rapid and effective data processing.

The output of the MatMul operator 220I is provided to the add operator 240B. the operators 240B also receives the output of the operators 240A. The operators 240B may perform an elementwise addition on the two inputs. The elementwise addition may be denoted as f(x, y)=x+y. In an example, the two inputs are each a vector including 4 data elements, and the output of the operators 240B is also a vector including 4 data elements. The output of the operators 240B may be an output of the DNN model 200.

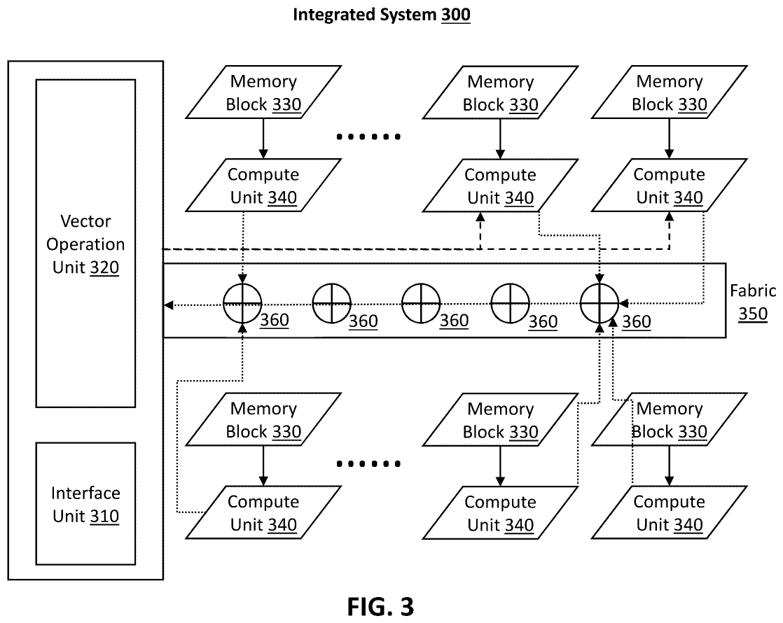

FIG. 3 illustrates an integrated system 300 for optimized DNN computation, in accordance with various embodiments. The integrated system 300 may implement a DNN model, such as the DNN model 200 in FIG. 2. The integrated system 300 may be an example of the IC device 100 in FIG. 1. As shown in FIG. 3, the integrated system 300 includes an interface unit 310, a vector operation unit 320, memory blocks 330 (individually referred to as “memory block 330”), compute units 340 (individually referred to as “compute unit 340”), fabric 350, and adders 360 (individually referred to as “adder 360”). In other embodiments, the integrated system 300 may include fewer, more, or different components. For instance, the integrated system 300 may include a different number of memory blocks 330, compute units 340, or adders 360. Also, the layout of the components may be different from the layout shown in FIG. 3.

The interface unit 310 may receive data from or send data to other devices or systems. For instance, the interface unit 310 may receive DNN inputs or send out DNN outputs. In some embodiments, the interface unit 310 may include a PCI interface, such as a PCIe unit. The interface unit 310 may provide received data to the vector operation unit 320 for initial processing. For instance, the interface unit 310 may provide a DNN input to the vector operation unit 320 for performing vector operations in the DNN. The DNN input may be an input prompt from a user. The input prompt may include one or more words, images, audio signals, other types of data, or some combinations thereof. The interface unit 310 may also send internal parameters of the DNN to the vector operation unit 320 or memory blocks 330. The internal parameters may have values determined by training the DNN.

The vector operation unit 320 may implement vector operations in DNNs. The vector operations may include embedding operation, rotary operation, activation function, RMS normalization, inverse operation, or other types of vector operation. In some embodiments, the vector operation unit 320 may include the tokenizer unit 112, embedder unit 113, RMS normalizer unit 114, rotary embedder unit 115, SiLU unit 116, SoftMax unit 117, and sampler unit 118 in FIG. 1. The vector operation unit 320 can accelerate the processing of DNNs, such as LLMs. In some embodiments, the vector operation unit 320 executes a wide range of mathematical operations on vectors, which can be essential for the various stages of model computation, including embedding and rotary transformations.

In some embodiments, the vector operation unit 320 includes one or more registers, such as vector register and scalar register. In an example, the vector operation unit 320 is equipped with four vector registers (V1, V2, V3, V4) and four scalar registers (S1, S2, S3, S4). The registers may store intermediate data or operands during computations. In some embodiments, the registers may store numbers of various formats. For instance, a register may hold BF16 numbers, where BF stands for bfloat16. Additionally or alternatively, a register may hold FP4, FP8, FP16, FP32, or other types of floating-point numbers.

The vector operation unit 320 can perform complex calculations with high precision and efficiency. In some embodiments, the vector operation unit 320 supports an extensive set of instructions, including addition (ADD), multiplication (MUL), exponential functions (EXP), and vector-specific operations like finding maximum (MAX_V), minimum (MIN_V), and summation (SUM_V). Additionally, the vector operation unit 320 may incorporate look-up tables (LUTs) for quick access to precomputed values used in activation functions such as SiLU, GILU, and rectified linear unit (ReLU), as well as for RMS and inverse computations. For instance, one or more LUTs may store precomputed output values of an activation function. An LUT entry may specify an input value or a range of input values and specify the precomputed output value for the input value or the input value range. After the vector operation unit 320 receives an input value to the activation function, the vector operation unit 320 (or the LUT of the vector operation unit 320) may output the precomputed output value. In some embodiments, the precomputed values may be computed offline, e.g., before the execution of the DNN model starts.

The table below lists vector instructions of the vector operation unit 320, in accordance with various embodiments. The vector operation unit 320 may also feature masking options to selectively process elements and instructions for handling immediate values and addressing. By integrating these capabilities, the vector operation unit 320 can significantly enhance the computational throughput and efficiency of the integrated system 300, enabling real-time processing and scalable deployment of large-scale models.

Instructions:

| | |
|---|---|
| ADD | C = A + B |
| MUL | C = A * B |
| EXP | C = EXP(A) |
| MAX_V | C = MAX{A} |
| MIN_V | C = MIN{A} |
| SUM_V | C = SUM{A} |
| LUT_S | C = LUT{A}, LUT address B |
| LOAD | LOAD A to address B |
| STORE | STORE A in address B |
| RX | |
| TX | |

RMS micro-code (mask = 3072):

| | | |
|---|---|---|
| LOAD_V | Load (V3) | Load weights vector from memory |
| GET_V | Get(V1) | |
| MUL | V2 = V1*V1 | |
| SUM_V | S1 = Sumall(V2) | |
| LUT_S | S2 = LUT1(S1) | RMS formula: 1/(sqrt(x/3096) + |
| | | 10\hat{ } − 5) |
| Set | S2 −>V4 | |
| MUL | V2 = V4*V1 | |
| MUL | V1 = V2*V3 | |
| SEND_V | Send(V1) | |

SoftMax micro-code (mask = pos):

| | | |
|---|---|---|
| ASSIGN_SI | S2 = Immediate | S2 = 1/sqrt(128) |
| GET_V | Get(V1) | |
| MAX_V | S1 = Max(V1) | |
| ADD_SV | V2 = S1 + V1 | with minus option |
| MUL_SV | V1 = S2 * V2 | |
| EXP_V | V2 = Exp (V1) | |
| SUMALL_V | S1 = Sum(V2) | |
| LUT_S | S2 = LUT2(S1) | inverse formula: 1/x |
| MUL_SV | V1 = S2 * V2 | |
| SEND_V | Send(V1) | |

Scaling micro-code (mask = 3072)

| | | |
|---|---|---|
| ASSIGN_SI | S4 = Immediate | |
| GET_V | Get(V1) | S4 = 1/256 |
| MAX_V | S1 = Max(V1) | |
| MIN_V | S2 = Min (V1) | |
| ADD_SS | S3 = S1 + S2 | |
| MUL_SS | S1 = S4*S3 | With minus on S2 |
| MUL_SV | V2 = S1 * V1 | |
| SEND_V | Send(V1) | |

In an example, the vector operation unit 320 may perform the following flow for an embedding operation:
LOAD_V: Load the initial embedding vectors into the registers;
GET_V: Retrieve the required vectors;
MUL: Multiply the vectors as needed;
EXP: Apply exponential functions using LUTs for activation functions like SiLU/GILU/RELU;
SUM_V: Sum the vector elements; and
SEND_V: Send the processed vectors to the next stage.

In an example, the vector operation unit 320 may perform the following flow for a rotary operation:
ASSIGN_SI: Assign an immediate value to a scalar register;
GET_V: Retrieve the vectors for rotary embeddings;
MAX_V: Find the maximum value in the vector;
ADD_SV: Add scalar and vector values;
MUL_SV: Multiply scalar and vector values;
EXP_V: Apply exponential function to vectors;
SUMALL_V: Sum all vector elements;
LUT_S: Look-up table operations for further transformations; and
SEND_V: Send the final vectors for further processing or storage.

In some embodiments, data may be transferred between the vector operation unit 320 and memory blocks 330. For instance, data (e.g., vectors) may be loaded into registers of the RMS normalizer 210 from the memory blocks 330, or vice versa. In some embodiments, loading a vector from memory to registers takes 512 cycles, which may utilize one memory bank of 256 bits. Data loading can be done in parallel with computation to avoid performance impacts.

The memory blocks 330 store data processed or generated by the compute units 340. The data may include data received by the interface unit 310 (e.g., weights), data computed by the vector operation unit 320, and data computed by the compute units 340. In some embodiments, the memory blocks 330 may constitute one or more memories, such as DRAM, ROM, and so on. In the embodiments of FIG. 3, each memory block 330 corresponds to a compute unit 340 and is communicatively coupled to the compute unit 340. For instance, the memory block 330 is connected to the compute unit 340 through a via. The via may be a TSV. The memory block 330 may store data processed or generated by the compute unit 340, and the data may be transferred between the memory block 330 and the compute unit 340 through the via. Data stored in the memory blocks 330 can be quickly accessed by the compute units 340 due to the proximity of the memory blocks 330.

The compute units 340 may perform computations in matrix multiplication operations of the DNN. In some embodiments, each compute unit 340 may be or may include a multiply-add unit. Examples of the compute unit 340 include the multiply-add units 122 or multiply-add unit 132 in FIG. 1. Data transfers among various combinations of the interface unit 310, vector operation unit 320, memory blocks 330, and compute unit 340 may be facilitated by the fabric 350.

The fabric 350 allows the interface unit 310, vector operation unit 320, memory blocks 330, and compute unit 340 to communicate with each other. In some embodiments, the fabric 350 may connect the interface unit 310, vector operation unit 320, memory blocks 330, and compute unit 340. For instance, the fabric 350 may include a network of conductive pathways that connect the interface unit 310, vector operation unit 320, memory blocks 330, and compute unit 340. The conductive pathways may include metal wires. The fabric 350 can provide high-bandwidth and low-latency connections. In some embodiments, the fabric 350 may build interconnect directly into the silicon wafer itself. The fabric 350 can enable high-density integration and efficient packaging.

The adders 360 are arranged on the fabric 350 as shown in FIG. 3. In some embodiments, the adders 360 may perform summations in matrix multiplication operations of the DNN. Outputs of the compute unit 340 may be provided to the adders 360. The adders 360 may be arranged in a sequence. The first adder 360 may receive the outputs of two or more compute unit 340 and compute a sum from the outputs of the two or more compute unit 340. The second adder 360 may receive the output of the first adder 360 and compute a sum of the output of the first adder 360 and one or more other compute unit 340. Similarly, the third adder 360 may may receive the output of the second adder 360 and compute a sum of the output of the second adder 360 and one or more other compute unit 340. This may continue till the last adder 360 computes an output data point (e.g., an output activation) of a matrix multiplication operation.

In some embodiments, the interface unit 310, vector operation unit 320, compute unit 340, fabric 350, and adders 360 may be in a logic die, while the memory blocks 330 may be in a memory die. This 3D design may be achieved by wafer bonding a memory wafer (e.g., a DRAM wafer) on top of a logic wafer, or vice versa. After the wafers are diced, each chip stack may include a high-density memory on the top and specialized compute logic on the bottom (or vice versa), and the memory and compute logic may be connected by TSVs. The logic layer, which is equipped with the vector operation unit 320, compute unit 340, and adders 360, may be capable of handling all transformer-related processing steps, including activation, normalization, rotary embedding, dynamic scaling, sampling, and so on.

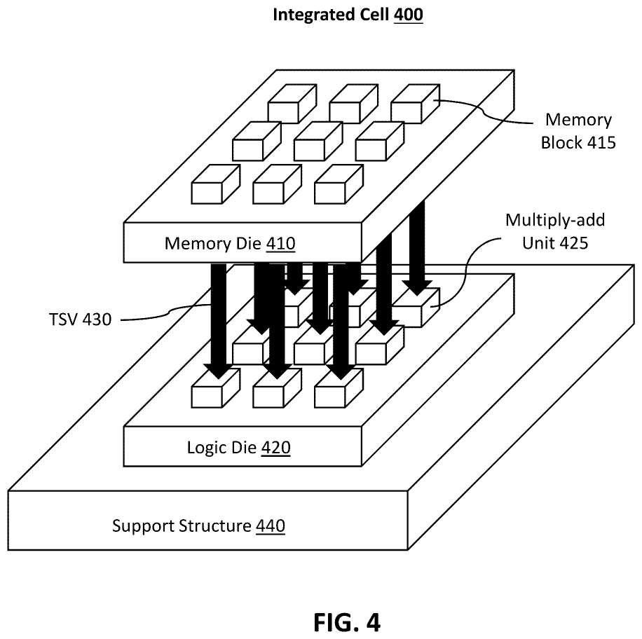

FIG. 4 illustrates an integrated cell 400, in accordance with various embodiments. The integrated cell 400 may be part of a 3D integrated system, such as the integrated system 300 in FIG. 3. As shown in FIG. 4, the integrated cell 400 includes a memory die 410, a logic die 420, TSVs 430 (individually referred to as “TSV 430”), and a support structure 440. The logic die 420 is between the memory die 410 and support structure 440. In other embodiments, the integrated cell 400 may include fewer, more, or different components. Additionally or alternatively, the components of the integrated cell 400 may be arranged differently. For instance, the memory die 410 may be between the logic die 420 and the support structure 440.

The memory die 410 may be a memory, e.g., a DRAM or sequential ROM. The memory die 410 includes memory blocks 415 (individually referred to as “memory block 415”). Each memory block may be a data storage unit that can store data used or generated during inference of a DNN model. The memory block 415 may be examples of the memory blocks 330 in FIG. 3.

The logic die 420 includes multiply-add units 425 (individually referred to as “multiply-add unit 425”). Each multiply-add unit 425 is connected to a memory block 415 in the memory die 410 through a TSV 430. The multiply-add unit 425 may receive data from the memory block 415 or send data to the memory block 415 through the TSV 430. Even though FIG. 4 shows nine memory blocks 415 and nine multiply-add units 425, the integrated cell 400 may include fewer or more memory blocks 415 or multiply-add units 425. In some embodiments, the integrated cell 400 may include multiple memory dies or multiple logic dies. The multiply-add units 425 may be examples of the compute unit 340 in FIG. 3.

The support structure 440 may be a substrate. In some embodiments, the integrated cell 400 is at least part of an IC package, and the support structure 440 is a package substrate. The support structure 440 may be formed of a dielectric material (e.g., a ceramic, a glass, a combination of organic and inorganic materials, a buildup film, an epoxy film having filler particles therein, etc., and may have embedded portions having different materials). The support structure 440 may also include one or more conductive pathways extending through the dielectric material. The one or more conductive pathways may allow circuitry within the dies to communicate with each other.

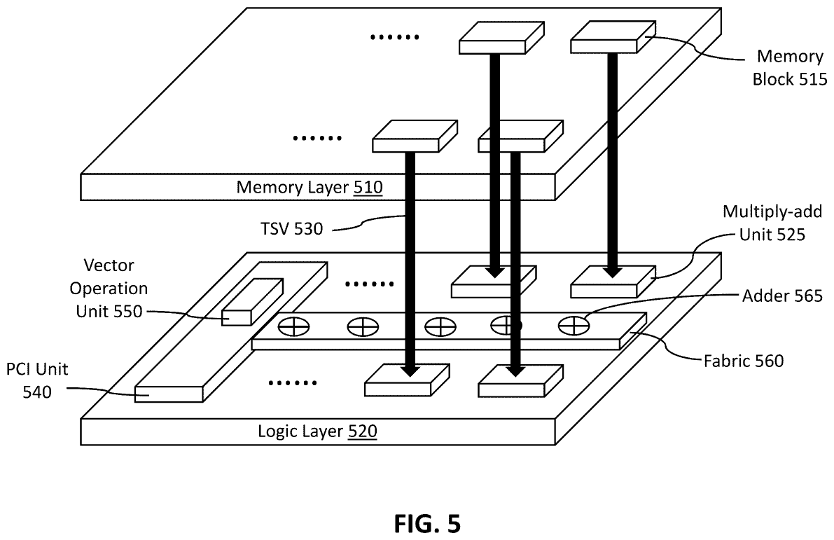

FIG. 5 illustrates a perspective view of a 3D integrated system 500, in accordance with various embodiments. The 3D integrated system 500 may implement a DNN model, such as a transformer model. The 3D integrated system 500 may be an example of the IC device 100 in FIG. 1 or the integrated system 300 in FIG. 3. As shown in FIG. 5, the 3D integrated system 500 includes a memory layer 510, a logic layer 520 and TSVs 530 (individually referred to as “TSV 530”). In other embodiments, the d integrated system 500 may include fewer, more, or different components.

The memory layer 510 may be a memory, such as a DRAM. The memory layer 510 includes memory blocks 515 (individually referred to as “memory block 515”). In an embodiment, each memory block 515 is a DRAM block. In another embodiment, each memory block 515 is a ROM block, such as a sequential ROM block. In yet another embodiments, the memory blocks 515 include one or more DRAM blocks and one or more ROM blocks. The memory layer 510 may be a memory wafer or memory die, such as the memory die 410 in FIG. 4. In some embodiments, the 3D integrated system 500 may include multiple memory dies.

The logic layer 520 includes multiply-add units 525 (individually referred to as “multiply-add unit 525”), PCI unit 540, vector operation unit 550, fabric 560, and adders 565. The multiply-add units 525 may be examples of the compute unit 340 in FIG. 3. Each multiply-add unit 525 is connected to a different memory block 515 through a TSV 530. As shown in FIG. 5, the multiply-add units 525 are arranged on two opposite sides of the fabric 560. The multiply-add units 525 may be specialized compute units that can perform the complex mathematical operations required by transformer architecture. The logic layer 520 may be a logic wafer or logic die, such as the logic die 420 in FIG. 4.

The PCI unit 540 facilitates external communications of the 3D integrated system 500. The PCI unit 540 may be an interface that connects the 3D integrated system 500 to one or more other devices, such as a computer's motherboard, CPU, GPU, etc. The PCI unit 540 may be an example of at least part of the interface unit 310 in FIG. 3. In some embodiments, the PCI unit 540 facilitates the PCI Express (PCIe) standard and uses lanes to provide high data transfer speeds. The PCI unit 540 may act as a bus or data highway and allow the 3D integrated system 500 to communicate with a host, e.g., a CPU. The PCI unit 540 may receive data from the host for other components of the 3D integrated system 500 to process and send data computed by for other components of the 3D integrated system 500 to the host.

The vector operation unit 550 is a compute unit that can process data to perform vector operations in the DNN model. The data processed by the vector operation unit 550 may be received from the PCI unit 540. The vector operation unit 550 may include registers that can store the received data or data computed by the vector operation unit 550. The registers may include both vector registers and scalar registers. The vector operation unit 550 can perform various operations required by transformers in accordance with vector instructions. In an example, a vector instruction may define or specify one or more mathematical computations required by the DNN model. Such vector instructions may include ADD, MUL, EXP, MAX_V, MIN_V, SUM_V, LUT_S, and so on. In another example, a vector instruction may indicate data transferred required by the DNN model, e.g., retrieving data or sending data.

In the embodiments of FIG. 5, the vector operation unit 550 is arranged on the PCI unit 540. In other embodiments, the vector operation unit 550 may be arranged next to the PCI unit 540. In some embodiments, one or more other units may be arranged on the PCI unit 540. For example, a flow control unit may be arranged on the PCI unit 540. The flow control unit may orchestrate computations done by the vector operation unit 550 and multiply-add units 525 based on a timing sequence of operations in the DNN model. An example of the flow control unit is the flow control unit 111 in FIG. 1. As another example, a decrypt unit may be arranged on the PCI unit 540. The decrypt unit may decrypt data received by the 3D integrated system 500. The decrypt unit can ensure secure communication of the 3D integrated system 500.

The fabric 560 facilitates communications within the 3D integrated system 500. The fabric 560 may be connected to the PCI unit 540, vector operation unit 550, multiply-add units 525, and adders 565. In some embodiments, the fabric 560 may facilitate transfer of data computed by the vector operation unit 550 to the multiply-add units 525. The fabric 560 may also facilitate transfer of data computed by the multiply-add units 525 to the adders 565. The fabric 560 may further facilitate transfer of data computed by an adder 565 to another adder 565. In some embodiments, the adders 565 may be arranged in a sequence. In an example, the adder 565 that is the furthest from the vector operation unit 550 is the first adder of the sequence, while the adder 565 that is the closest to the vector operation unit 550 is the last adder in the sequence. The first adder may receive data points computed by two or more multiply-add units 525 and compute a sum of the data points. The sum may be provided to the second adder, which may then compute a new sum from the sum computed by the first adder and one or more data points computed by one or more other multiply-add units 525. This may continue till the last adder compute a final output data point or an intermediate sum that is to be further summed with other data points.

The memory layer 510 and logic layer 520 constitute a 3D structure, in which high-density memory modules in the memory layer 510 are positioned directly above the logic layer 520. These memory modules can provide local, high-speed data storage, minimizing the distance data needs to travel and thus reducing latency. The memory layer 510 and logic layer 520 are interconnected through the TSVs 530. The TSVs 530 can provide vertical interconnections that link the memory modules in the top layer with the multiply-adders in the bottom layer. The TSV 530 can facilitate high-bandwidth, low-latency data transfer between the memory and compute units, effectively eliminating the memory wall. Even though the memory layer 510 is on top of the logic layer 520 in FIG. 5, the logic layer 520 may be on top in other embodiments.

The 3D integrated system 500 is an example of novel 3D-integrated compute and memory systems that are specifically designed to accelerate operations in DNNs such as transformers. In some embodiments, the 3D integrated system 500 may be fabricated by bonding a DRAM wafer directly on top of a logic wafer. After diced, each chip stack may include high-density memory on the top layer and specialized compute logic on the bottom layer, interconnected by TSVs. FIG. 5 shows a vertical integration of these components, highlighting the compact and efficient design. The logic layer may include advanced vector operation units and multiply-add units tailored for transformer-related processing steps such as activation, normalization, and rotary embedding. By placing memory and compute units in close proximity within a single die, the design can minimize data transfer latencies and power consumption, effectively eliminating the memory wall. This configuration can not only enhance computational speed but also boosts energy efficiency, making it ideal for applications requiring real-time processing, such as edge computing, mobile devices, and IoT systems. The modular nature of the chip stacks allows for scalable deployment, adaptable to various computational demands and future technological advancements. The system can scale efficiently with large models, leveraging the transformer architecture, and ensure that weights remain within individual dies while only the activation vectors are transferred. This can require minimal bandwidth, allowing for low-bandwidth die-to-die connections and enabling the system to grow seamlessly with increasing model sizes. FIG. 5 provides a visual representation of the interconnected layers and the efficient use of space, further showing the optimization of deep learning model computations.

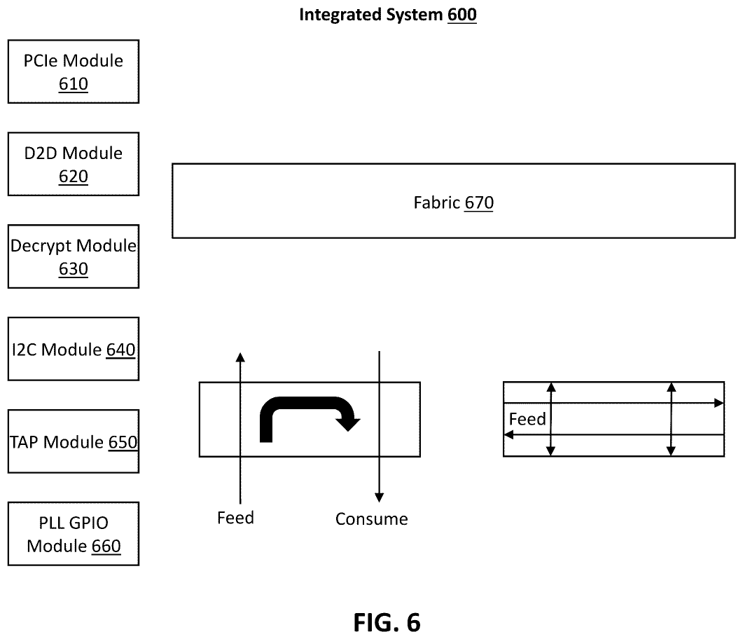

FIG. 6 illustrates interconnect and fabric integration within an integrated system 600, in accordance with various embodiments. The integrated system 600 may implement a DNN model, such as a transformer model. The integrated system 600 may be an example of the IC device 100 in FIG. 1, the integrated system 300 in FIG. 3, or the 3D integrated system 500 in FIG. 5. For the purpose of illustration and simplicity, FIG. 6 shows a PCIe module 610, D2D module 620, decrypt module 630, I2C module 640, TAP (Test Access Port) module 650, PLL GPIO (Phase-Locked Loop General-Purpose Input/Output) module 660, and fabric 670. The integrated system 600 includes additional components that are not shown in FIG. 6. For instance, the integrated system 600 includes a memory die and compute units that are not shown in FIG. 6.

FIG. 6 shows an example of the system interconnect and fabric integration within a 3D-integrated compute and memory architecture. The PCIe module 610, D2D module 620, decrypt module 630, I2C module 640, TAP module 650, PLL GPIO module 660, and fabric 670 are on the left side of the layout. The PCIe module 610, D2D module 620, decrypt module 630, I2C module 640, TAP module 650, PLL GPIO module 660, and fabric 670 may be modules in an interface unit, such as the interface unit 310. These modules may be interface modules that can function as the primary channels for external communication, data transfer, and system control, ensuring seamless interaction with peripheral devices and other system components. In some embodiments, the interface modules may perform functions of the flow control unit 111 in FIG. 1.

The PCIe module 610 may facilitate external communication of the integrated system 600 under the PCIe standard. The D2D module 620 may facilitate die-to-die communication. For instance, the D2D module 620 may facilitate data transfer between a logic die of the integrated system 600 and a memory die of the integrated system 600. The logic die may include the interface modules and the fabric 670. The memory die may include DRAM blocks or ROM blocks. The decrypt module 630 may decrypt data received by the integrated system 600. The decrypt module 630 may incorporate various decryption tools, keys, or other information needed for decryption. In an example, the decrypt module 630 may identify the method in which the data was encrypted, then obtain the key for either symmetric or asymmetric encryption. The decrypt module 630 may use a decryption tool or function and execute the decryption by providing the encrypted data and the key to the tool or function. The decrypt module 630 may also verify the decryption result and ensure that the output is correct. The decrypt module 630 may facilitate secure communication.

The I2C module 640 may facilitate connecting different types of devices, e.g., connecting one or more microcontrollers to one or more peripheral devices. For instance, the I2C module 640 may use a master-slave architecture where one or more master devices initiate communication to control one or more slave devices. The I2C module 640 may allow different types of devices to communicate on the same bus using unique addresses. The TAP module 650 may test and debug circuits and devices in the integrated system 600. In some embodiments, the TAP module 650 may allow external test equipment to access the internal state and logic of the integrated system 600 for various operations, such as testing debugging, etc. The TAP module 650 can ensure robust testing and debugging capabilities, essential for maintaining system reliability. The PLL GPIO module 660 may synchronize frequencies of signals. For instance, the PLL GPIO module 660 may synchronize an output signal's phase and frequency to an input signal. The PLL GPIO module 660 can ensure that data sent or received through the GPIO pins is timed correctly and reliably with the rest of the integrated system 600. The I2C module 640 and PLL GPIO module 660 can ensure precise control of peripheral devices, such as memory blocks.

The fabric 670 may be a high-bandwidth, scalable interconnect fabric that facilitates efficient data flow between the interface modules and the internal computational modules. The fabric 670 may be designed to handle multiple data paths simultaneously, represented by the arrows shown in FIG. 6, ensuring low-latency and high-throughput communication. The arrows illustrate the data flow and routing capabilities of the fabric 670. The vertical and horizontal arrows indicate the bidirectional data paths, allowing for flexible and efficient data transfer between different parts of the integrated system 600. The design of the fabric 670 can ensure that data can be routed optimally, avoiding bottlenecks and maintaining high performance.

FIG. 6 shows a sophisticated interconnect and fabric architecture that can underpin 3D integrated systems, enabling it to support complex computational workloads with high efficiency and scalability. The integration of the fabric 670 with the interface modules can enable the integrated system 600 to support a wide range of functionalities, from high-speed data transfer via PCIe to secure communication through decrypt and precise control using 12C and PLL GPIO.

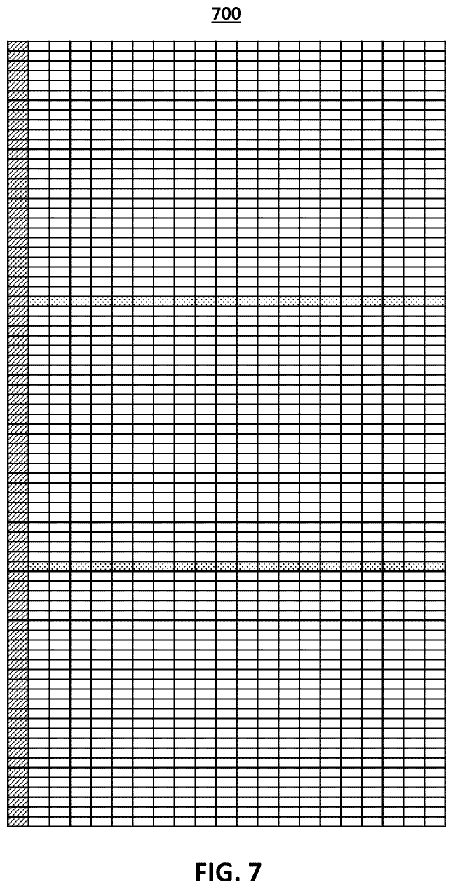

FIG. 7 illustrates a layout of a multiply-add unit 700, in accordance with various embodiments. The multiply-add unit 700 may be a multiply-add unit in a 3D integrated compute and memory system The multiply-add unit 700 may perform multiply-accumulate operations in DNN models, such as transformer models. The multiply-add unit 700 is an example of the multiply-add units 122 in FIG. 1, multiply-add unit 132 in FIG. 1, compute unit 340 in FIG. 3, multiply-add units 425 in FIG. 4, and multiply-add units 525 in FIG. 5.

The layout of the multiply-add unit 700 may be meticulously organized to maximize computational efficiency and throughput. For the purpose of illustration, FIG. 7 shows a grid consisting of 1,560 partitions, each representing a RAM-multiply-add partition with a memory capacity of 2 MB. These partitions are systematically arranged in a dense matrix to ensure optimal data access and processing speed. The grid is segmented into blocks with the multiply-add partitions, shown by the dotted pattern, forming the core computational units. These units may execute essential operations like multiplication and addition, which are fundamental to the computations in models such as LLMs. The layout can ensure that each multiply-add unit is in close proximity to the neighboring units, facilitating rapid data exchange and minimizing latency.

Interspersed within the grid are 40 fabric partitions, which serve as connective tissue within the architecture. These fabric partitions can provide critical interconnects and routing paths that enable efficient communication between the multiply-add units. This design allows for scalable data flow and ensures that the system can handle large-scale computations without bottlenecks. The leftmost column, marked with diagonal stripes, represents the control and interface logic that orchestrates the operations across the entire grid. This includes managing data flow, synchronizing operations, and interfacing with external components through the PCI interface. The layout of the multiply-add unit 700 can provide a balanced and highly efficient computational environment, capable of supporting the intensive demands of modern large language models. The integration of multiply-add partitions with strategically placed fabric partitions ensures that the system can scale effectively while maintaining high performance and low latency.

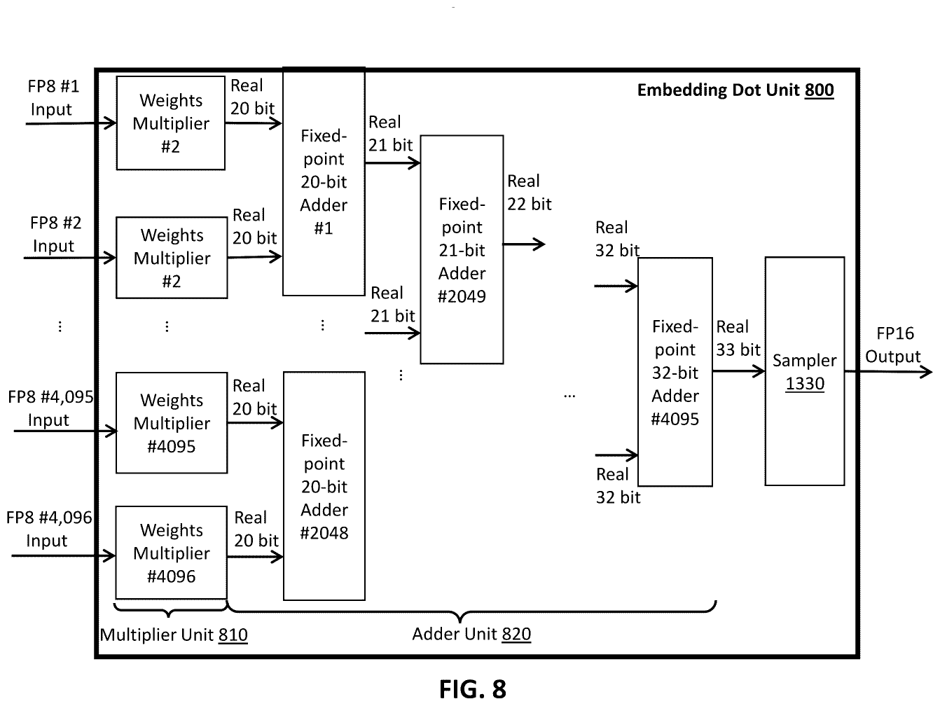

FIG. 8 illustrates an embedding dot unit 800, in accordance with various embodiments. The embedding dot unit 800 may be a hardware implementation of embedding computations in a DNN model. The embedding dot unit 800 may be an example of the embedding dot unit 121 in FIG. 1. As shown in FIG. 8, the embedding dot unit 800 includes a multiplier unit 810, an adder unit 820, and a sampler 830. In other embodiments, the embedding dot unit 800 may include fewer, more, or different components. The multiplier unit 810 may perform elements dot product operation between an embedding vector (e.g., FP8 embedding vector) and a weights vector (e.g., FP6 weights vector read from sequential ROM) every cycle. The multiplier unit 810 includes a plurality of weights multipliers. In an example of FIG. 8, the embedding dot unit 800 may include 4,096 weights multipliers: weights multiplier #1 through weights multiplier #4,096. The weights multipliers may perform multiplication in parallel. The outputs (e.g., 4096 outputs) may be added together by the adder unit 820.

In the example of FIG. 8, the adder unit 820 includes 4,095 adders. These adders are arranged in a tree or hierarchical structures. In some embodiments, the adder unit 820 may use a special fixed-point adder with a relatively large number of bits (e.g., 20 bits, 21 bits, . . . 32 bits). The 4,095 adders may be arranged in 8 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 8th tier outputs the final sum, which may be a 33-bit number, which is then provided to the sampler 830. The sampler 830 may be a FP16 sampler. The sampler 830 may resample the final sum into a floating-point representation. The embedding dot unit 800 may generate an FP16 output. Using a large number of bits in the adder unit 820 can prevent overflow during many stages/layers of adding.

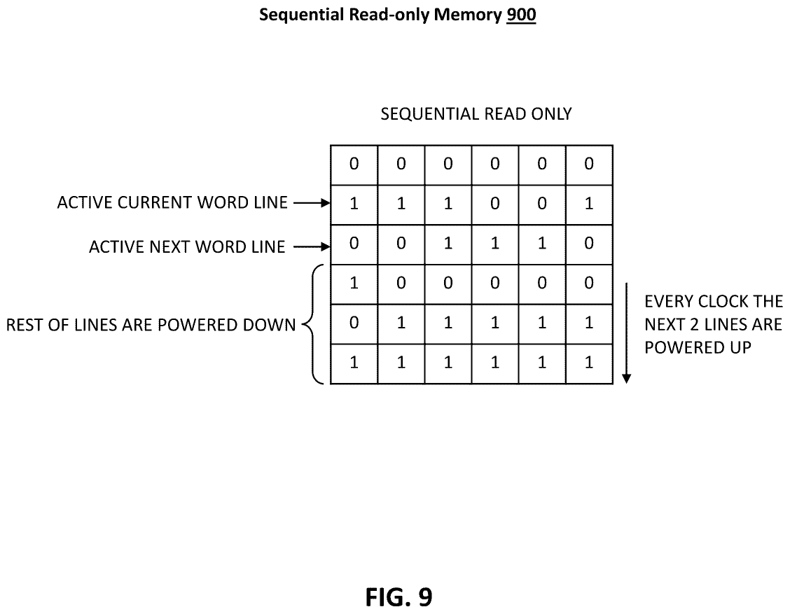

FIG. 9 illustrates a sequential ROM 900, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. The sequential ROM 900 may be an example of the ROMs described above.

For the purpose of illustration, the sequential ROM 900 in FIG. 9 has six word lines. The sequential ROM 900 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential ROM 900 can power down the rest of the word lines, or the rest of the word lines in the sequential ROM 900 can remain powered down. At the next clock or time slot, the active current word line is powered down, the active next word line is already powered up, and a further active next word line is powered up. At every clock or time slot, two word lines may be powered up in the sequential ROM 900. The two active word lines that are powered up may get moved by one word line down the sequential ROM at every clock or time slot.

In some embodiments, one or more sequential ROMs may be provided on the chip to store various weight matrices for a transformer model:

| Num. Lines | Layer | Matrix |
|---|---|---|
| 16 | 0 | W_{Q} |
| 4 | 0 | W_{K} |
| 4 | 0 | W_{V} |
| 16 | 0 | W_{O} |
| 112 | 0 | W₁ |
| 56 | 0 | W₂ |
| . . . | . . . | . . . |
| 16 | 31 | W_{Q} |
| 4 | 31 | W_{K} |
| 4 | 31 | W_{V} |
| 16 | 31 | W_{O} |
| 112 | 31 | W₁ |
| 56 | 31 | W₂ |
| 16 | 31 | W_{Q} |
| 501 | — | W_{cls} |

In some embodiments, an IC device implementing a DNN may have 1,048,576 ROMs (e.g., sequential ROMs) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

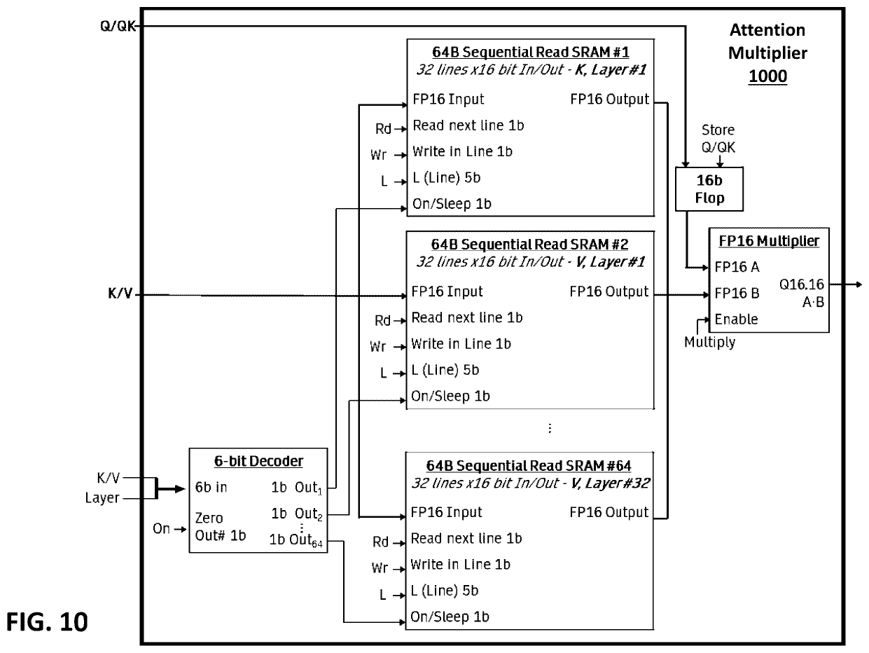

FIG. 10 illustrates an attention multiplier unit 1000 with a sequential read/write memory, in accordance with various embodiments. The attention multiplier unit 1000 may be a hardware implementation of attention multiplication operations in a DNN. The attention multiplier unit 1000 may be an example of the attention dot unit 130 in FIG. 1.

In the embodiments of FIG. 10, the attention multiplier unit 1000 includes sequential read/write memories. A sequential read/write memory may involve using an SRAM in a special configuration that it is not dynamically readable but is built up sequentially to reduce power and area. As shown in FIG. 10, the sequential read/write memories in the attention multiplier unit 1000 are sequential read SRAMs. An SRAM that can be read sequentially or written sequentially has drastically simplified logic and circuitry for reads or writes. A sequential read/write memory can be used with or in an attention dot unit to supply weights to the attention multiplier unit 1000. In one implementation, the attention dot unit having the attention multiplier unit 1000 may receive an input number and multiplies it by a number from SRAM (e.g., sequential read/write memory) every clock cycle. 64 SRAMs may be used to store the 32 layers and K vs. V separately, so the SRAM can read lines sequentially.

According to one aspect, the sequential read/write memory may be referred to as key-value SRAM (KV SRAM), which can store data in key-value pairs. KV SRAM can enable storing the attention history (e.g., cached keys and values) of a transformer block. In some embodiments, the attention dot unit may receive an input number and multiplies it by a number from SRAM in every clock cycle. 64 SRAMs are used to store the 32 layers and K vs. V separately, so the SRAM can read lines sequentially.

In some embodiments, a sequential read/write memory may store a KV cache for the DNN. To improve computational efficiency, one or more KV caches can be included on chip with the additional dot unit(s) to enhance the performance of the model by temporarily storing frequently accessed data. Keys and values computed in the attention mechanism can be cached to allow for rapid retrieval of information. In some embodiments, the key may represent a unique identifier for a specific input or query, while the value may include the corresponding output or computational result. This caching mechanism deals with dynamic data, and thus uses read/write memory, such as SRAM. The KV cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

In some embodiments, the queries, keys, or values may be FP16 values. The attention multiplier unit 1000 may receive a K/V control signal, layer control signal, SRAM read control signal, SRAM write control signal, SRAM line to write control signal, store Q/QK control signal, on/sleep control signal, other types of control signals, or some combination thereof. The attention multiplier unit 1000 may operate under the control signals. For instance, the decoder may turn on one of the 64 SRAMs based on the layer control signal (which may indicate which layer is being executed) and K/V control signal (which may indicate whether to multiply K or V). A control signal may have 1 bit. In an example where there are 16 attention dot units per head, 32 lines may be used. The output of the attention multiplier unit 1000 may be 32-bit numbers, such as 32-bit fixed-point so adders can use it. In some embodiments, there may be 65,536 instances of the attention multiplier unit 1000 in the IC device. 65,536 equals 32 heads times 16 dots/heads times 128.

In some embodiments, the attention multiplier unit 1000 is included in an attention dot unit to perform multiplication of two numbers (e.g., FP16 value and FP16 value), where one of the two numbers may be read from the sequential read/write memory storing the KV cache. As illustrated, the attention multiplier unit 1000 includes 64 sequential read SRAMs, and a 6-bit decoder. The decoder may turn on one of the 64 sequential read SRAMs to be used. Data may be read from the active sequential read SRAM serially, e.g., line by line. The data the active sequential read SRAM may be multiplied against the input by the FP16 multiplier. Many instances of attention multiplier unit 1000 may be included in an attention dot unit to perform elementwise multiplication, e.g., in parallel. The multiplication results of the instances of the attention multiplier unit 1000 may be summed by a tree adder to form a vector dot product result. The attention dot unit may perform many vector dot products to form a final matrix multiplication result.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, and U.S. patent application Ser. No. 19/244,318, filed on Jun. 20, 2025, each of which is hereby incorporated by reference in its entirety.

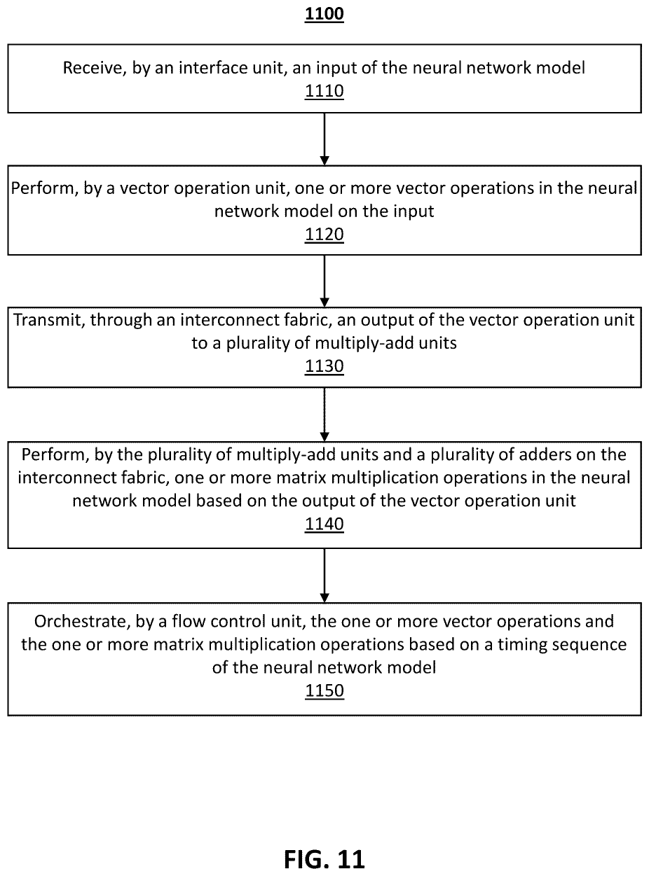

FIG. 11 is a flowchart showing a method 1100 of executing a DNN model, in accordance with various embodiments. The method 1100 may be performed by the integrated system 300 in FIG. 3. Although the method 1100 is described with reference to the flowchart illustrated in FIG. 11, many other methods for executing DNN models may alternatively be used. For example, the order of execution of the steps in FIG. 11 may be changed. As another example, some of the steps may be changed, eliminated, or combined.

The integrated system 300 receives 1110, by an interface unit, an input of the DNN model. In some embodiments, the interface unit includes a PCIe unit. In some embodiments, the interface unit includes a D2D unit, decrypt unit, I2C unit, TAP unit, or PLL GPIO unit. In some embodiments, the interface unit provides channels for external communication, data transfer, and system control, ensuring seamless interaction with peripheral devices and other system components.

The integrated system 300 performs 1120, by a vector operation unit, one or more vector operations in the DNN model on the input. In some embodiments, the one or more vector operations comprises an embedding operation, a rotary operation, an activation function, a RMS normalization, or an inverse operation. In some embodiments, the integrated system 300 performs one or more activation functions of the DNN model based on precomputed values of the one or more activation functions. The precomputed values of the one or more activation functions are stored in one or more look-up tables of the vector operation unit.

The integrated system 300 transmits 1130, through an interconnect fabric, an output of the vector operation unit to a plurality of multiply-add units. In some embodiments, the interconnect fabric is in the same die as the vector operation unit. In some embodiments, the integrated system 300 stores input data or output data of the plurality of multiply-add units in a plurality of memory blocks. Each multiply-add unit of the plurality of multiply-add units is coupled with a different memory block of the plurality of memory blocks. In some embodiments, the plurality of memory blocks includes a sequential random-access memory or a sequential ROM. In some embodiments, the integrated system 300 transfers data between a memory block and a corresponding multiply-add unit through a via. The plurality of multiply-add units are arranged in a logic die. The plurality of memory blocks are arranged in a memory die. The via extends between the logic die and the memory die.

The integrated system 300 performs 1140, by the plurality of multiply-add units and a plurality of adders on the interconnect fabric, one or more matrix multiplication operations in the DNN model based on the output of the vector operation unit. In some embodiments, the integrated system 300 transfers data points computed by two or more multiply-add units of the plurality of multiply-add units to a first adder of the plurality of adders. The first adder is to compute a sum of the data points. In some embodiments, the integrated system 300 transfers, through the interconnect fabric, sum computed by the first adder of the plurality of adders to a second adder of the plurality of adders. The second adder is to compute another sum from the sum computed by the first adder.

The integrated system 300 orchestrates 1150, by a flow control unit, the one or more vector operations and the one or more matrix multiplication operations based on a timing sequence of the DNN model. In some embodiments, the flow control unit is a part of the interface unit.

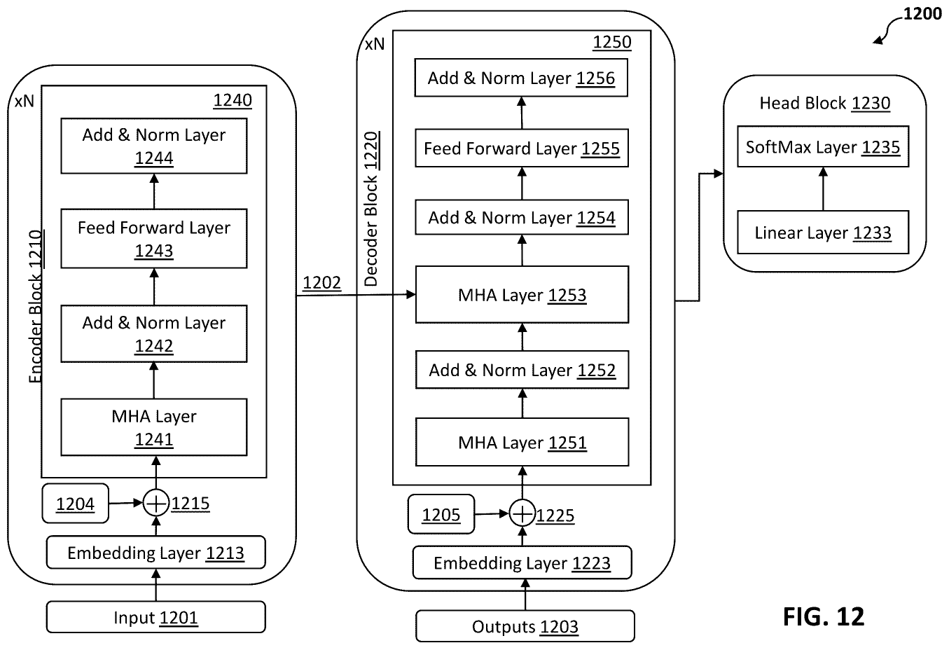

FIG. 12 illustrates an example transformer model 1200, in accordance with various embodiments. The transformer model 1200 is an example of the DNN models described above. The transformer model 1200 may be embedded on a chip. An example of the chip is the IC device 100 in FIG. 1. As shown in FIG. 12, the transformer model 1200 includes an encoder block 1210, a decoder block 1220, and a head block 1230. In other embodiment, different or additional components may be included in the transformer model 1200. Further, functionality attributed to a component of the transformer model 1200 may be accomplished by a different component included in the transformer model 1200 or a different model or module.

The encoder block 1210 receives input sequences and generates matrix representations of the input sequences. In the embodiments of FIG. 12, the encoder block 1210 receives an input 1201 and generates an encoder output 1202. The input 1201 may be an input prompt. In some embodiments, the input 1201 may include one or more input tokens, such as words, phrases, sentences, images, audio signals, other types of input tokens, or some combination thereof. In an example, the input 1201 may include a prompt received from a user of the transformer model 1200. The prompt may include a question or request made by the user. A word in the prompt may be an input token. In some embodiments, the encoder output 1202 may include one or more vectors that are contextualized representations of the input 1201. Each vector in the encoder output 1202 may represent a token in the input 1201 with contextual understanding.

The encoder block 1210 includes an embedding layer 1213, a positional encoding layer 1215, and a plurality of layers 1240 (individually referred to as “layer 1240”). In other embodiments, the encoder block 1210 may have different, fewer, or more components. Also, the arrangement of the components in the encoder block 1210 may be different from the arrangement shown in FIG. 12. For the purpose of illustration, the encoder block 1210 has N layers in FIG. 12, where N is an integer. Each layer 1240 may include one or more neural network operations. The layers 1240 may transform a sequence of embeddings into a representation that encapsulates the learned information from the input 1201. Different layers 1240 may have different internal parameters, e.g., different weights, bias, or other types of internal parameters. In some embodiments, the layers 1240 have identical components. The components in a layer 1240 may be layers and may also be referred to as sub-layers of the layer 1240. As shown in FIG. 12, a layer 1240 includes four sub-layers: a multi-head attention (MHA) layer 1241, an add & norm layer 1242, a feed forward layer 1243, and another add & norm layer 1244.

The decoder block 1220 iteratively generates outputs 1203 using encoded representations generated by the encoder block 1210. The decoder block 1220 includes an embedding layer 1223, a positional encoding layer 1225, and a plurality of layers 1250 (individually referred to as “layer 1250”). For the purpose of illustration, the decoder block 1220 has N layers in FIG. 12, where N is an integer. In the embodiments of FIG. 12, the number of layers 1250 in the decoder block 1220 is the same as the number of layers 1240 in the encoder block 1210. In other embodiments, the number of layers 1250 in the decoder block 1220 may be different from the number of layers 1240 in the encoder block 1210. Each layer 1250 may include one or more neural network operations. Different layers 1250 may have different internal parameters. In some embodiments, the layers 1250 may have identical components. The components in a layer 1250 may be layers and may also be referred to as sub-layers of the layer 1250. As shown in FIG. 12, a layer 1250 includes six sub-layers: an MHA layer 1251, an add & norm layer 1252, another MHA layer 1253, another add & norm layer 1254, a feed forward layer 1255, and another add & norm layer 1256.

In some embodiments, a sequence of inference stages is performed in the decoder block 1220 using encoder outputs, e.g., the encoder output 1202. A matrix may be predicted through each inference stage. The outputs 1203 may include a plurality of matrices. Each matrix may be further processed in the head block 1230 to predict a token. The plurality of matrices may be used to predict a sequence of tokens. For the first inference stage, the decoder block 1220 may receive one or more start tokens as input tokens and compute a first matrix from the input tokens and the output of the encoder block 1210. The first matrix may be used by the head block 1230 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 1230 receives the output of the decoder block 1220 and processes it in a linear layer 1233 and a SoftMax layer 1235. A linear operation may be performed on the output of the decoder block 1220 in the linear layer 1233. The linear operation may include a multiplication of the output of the decoder block 1220 with a weight matrix. The output of the linear layer 1233 may be a vector. In some embodiments, the head block 1230 may function as a classifier. The number of data elements in the vector computed in the linear layer 1233 may depend on the number of classes involved. In an example where there are M classes, where M is an integer, the vector computed in the linear layer 1233 may have M data elements representing the prediction for the M classes, respectively.

The output of the linear layer 1233 may be input into the SoftMax layer 1235. A SoftMax function may be applied on the output of the linear layer 1233 to compute probability scores. A probability score may have a value in the range from 0 to 12. In some embodiments, a probability value is computed for each data element in the vector computed in the linear layer 1233. The highest one of the probability scores may be the key. The corresponding index of the key may point to the token that the transformer model 1200 predicts as the next in the sequence. The final output of the transformer model 1200 may be the sequence of predicted tokens. In some embodiments, the head block 1230 may be a language modeling head.

An embedding layer (e.g., the embedding layer 1213 or the embedding layer 1223) converts an input of the embedding layer (e.g., the input 1201 or the outputs 1203) into one or more embeddings. An embedding may be a vector, which is also referred to as an embedding vector or a vector embedding. The vector embedding may include a sequence of data elements. In some embodiments, the embedding layer 1213 may generate a plurality of embeddings, each of which may be converted from a different input token in the input 1201. The embeddings may capture the semantic meaning of the tokens in the input 1201. The embeddings may be numerical representations that capture the relationships or meanings of words, phrases, or other data types. In an example where the input 1201 is a prompt including a sequence of words, the embedding layer 1213 may generate an embedding from each word in the input 1201. The embedding layer 1223 in the decoder block 1220 may generate a plurality of embeddings from tokens received by the decoder block 1220 in a similar manner as the embedding layer 1213.

A positional encoding layer (e.g., the positional encoding layer 1215 or the positional encoding layer 1225) performs positional encoding on embeddings generated in the corresponding embedding layer. In some embodiments, the positional encoding layer may apply one or more positional encoding vectors (e.g., a positional encoding vector 1204 or positional encoding vector 1205) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 1241, the MHA layer 1251, or the MHA layer 1253) may implement a multi-head attention mechanism, which may be a multi-head self-attention mechanism or a multi-head cross-attention mechanism. In some embodiments, the MHA layer 1241 or the MHA layer 1251 may implement a self-attention mechanism. For self-attention, the queries, keys, and values may come from the same place. For instance, for the MHA layer 1241, the queries, keys, and values may all come from the positional encoding layer 1215. For the MHA layer 1251, the queries, keys, and values may all come from the positional encoding layer 1225. The self-attention mechanism may enable the transformer model 1200 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 1241 may be computed from vector embeddings generated by the positional encoding layer 1215. The queries, keys, and values input into the MHA layer 1251 may be computed from vector embeddings generated by the positional encoding layer 1225. A query, key, or value may be a vector the represents a token in a sequence. In some embodiments, a query matrix Q∈ [symbol] may be computed by multiply an embedding matrix X∈ [symbol] (e.g., an embedding matrix computed in a positional encoding layer) with a weight matrix W_{q}∈ [symbol] where d is the dimension of a vector embedding, N is the number of vector embeddings in the embedding matrix, and h is the number of attention heads. Each row in the query matrix may be a query. A key matrix K∈ [symbol] may be computed by multiple an embedding matrix X∈ [symbol] (e.g., an embedding matrix computed in a positional encoding layer) with a weight matrix Wₖ∈ [symbol] Each row in the key matrix may be a key. A value matrix V∈ [symbol] may be computed by multiple an embedding matrix X∈ [symbol] (e.g., an embedding matrix computed in a positional encoding layer) with a weight matrix Wᵥ∈ [symbol] Each row in the value matrix may be a value.

In some embodiments, the MHA layer 1251 may implement masked multi-head self-attention. The MHA layer 1251 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 1253 may implement a cross-attention mechanism, such as encoder-decoder cross-attention. The MHA layer 1253 may use outputs from the previous layer (i.e., the add & norm layer 1252) as queries and use outputs from the encoder block 1210 as keys and values. The cross-attention can align the encoder's input with the decoder's, empowering the decoder block 1220 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$$Q {W}_{i}^{Q} ,$$

where Q is the query matrix and

$${W}_{i}^{Q}$$

∈ [symbol] is the weight matrix. A second linear layer may perform a multiplication of the key matrix with a weight matrix to compute a second parameter matrix. The second parameter matrix may be denoted as

$$K {W}_{i}^{K} ,$$

where K is the key matrix and

$${W}_{i}^{K}$$

∈ [symbol] is the weight matrix. A third linear layer may perform a multiplication of the value matrix with a weight matrix to compute a third parameter matrix. The third parameter matrix may be denoted as

$$V {W}_{i}^{V} ,$$

where V is the value matrix and

$${W}_{i}^{V}$$

∈ [symbol] is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat(head₁, head₂, . . . , headₕ)W^{O}, where Concat denotes concatenation, and W^{O}∈ [symbol] is the weight matrix in the corresponding linear layer.

An add & norm layer in the transformer model 1200, such as the add & norm layer 1242, 1244, 1252, 1254, and 1256, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 1242 is the MHA layer 1241. As another example, the preceding layer of the add & norm layer 1254 is the MHA layer 1253.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as where

$${μ}_{x y} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{x y}^{2} = {\sum }_{z = 1}^{Z} {D}_{x y z}^{2}$$

and a division computation denoted as

$${M}_{x y} = \frac{1}{\sqrt{\frac{1}{Z} \times ( {σ}_{x y}^{2} + ϵ \times Z )}} . {M}_{x y}$$

may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{xyz}^{′} = \frac{{A}_{x y z} - {μ}_{x y z}}{\sqrt{\frac{1}{Z} \times ( {σ}_{x y}^{2} + ϵ )}} = ( {A}_{x y z} - {μ}_{x y z} ) \times \frac{1}{\sqrt{\frac{1}{Z} \times ( {σ}_{x y}^{2} + ϵ )}} = {D}_{x y z} \times {M}_{x y z} .$$

The layer normalization operation may further compute

$${A}_{xyz}^{″} = {A}_{xyz}^{′} + \frac{{β}_{z}}{{γ}_{z}} and L {N}_{x y z} = {A}_{xyz}^{″} \times {γ}_{Z} . L {N}_{x y z}$$

may be the output of the layer normalization operation.

A feed forward layer (e.g., the feed forward layer 1243 and the feed forward layer 1255) may be a position-wise fully-connected feed forward network. In an example, the feed forward layer may include two linear layers with an activation function in between. An example of the activation function is ReLU.

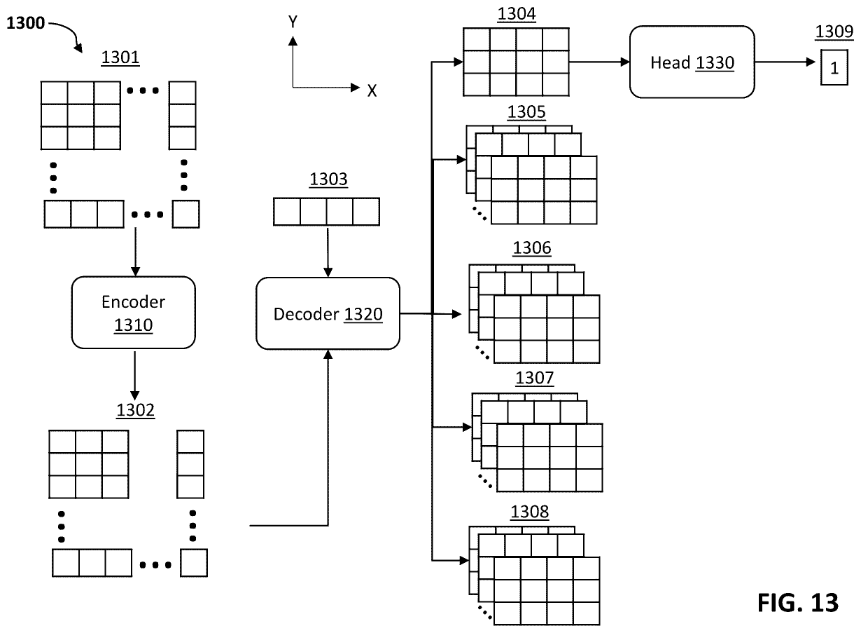

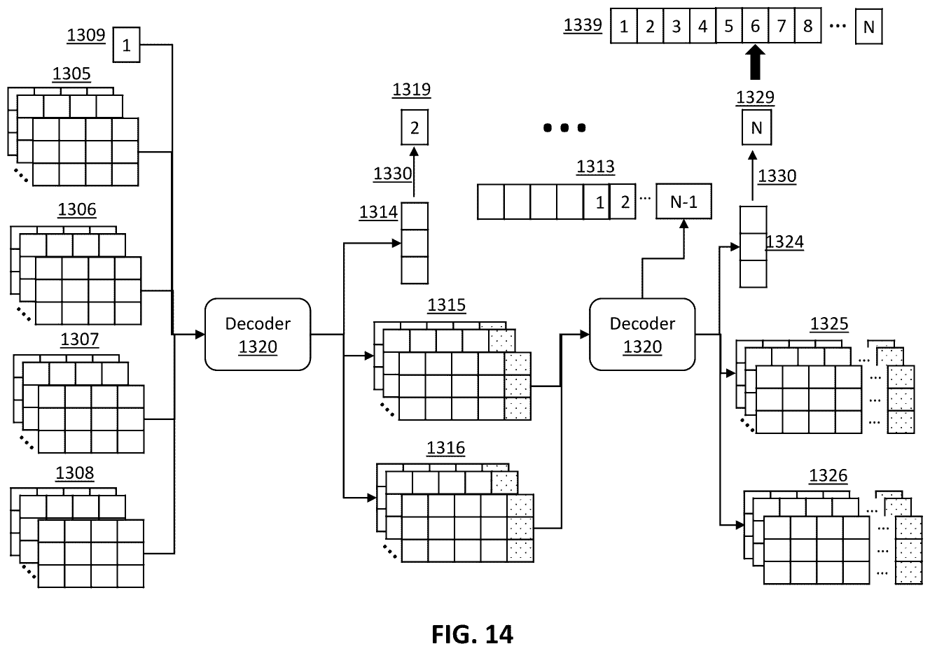

FIGS. 13 and 14 illustrate inferences of a transformer model 1300, in accordance with various embodiments. The transformer model 1300 may be an example of the DNN models described above. FIG. 13 illustrates the first inference process of the transformer model 1300, in accordance with various embodiments. The transformer model 1300 includes an encoder 1310, a decoder 1320, and a head 1330. In the embodiments of FIG. 13, the encoder 1310 receives an input tensor 1301. The input tensor 1301 may be a feature map extracted from one or more images, text documents, audio files, videos, other types of data, or some combination thereof. The encoder 1310 generates an output tensor 1302 from the input tensor 1301. The shape of the output tensor 1302 may be denoted as [batch size, SL_{encoder}, d_{model}], where SL_{encoder} may be the dimension along the X axis (i.e., the width of the output tensor 1302), and d_{model} may be the dimension along the Y axis (i.e., the height of the output tensor 1302). The encoder 1310 may include a plurality of layers arranged in a sequence, such as the layers inside the encoder 1310 in FIG. 17. The output tensor 1302 is provided to the decoder 1320.

The decoder 1320 receives the output tensor 1302 and an input sequence 1303. The input sequence 1303 may be a sequence of tokens. A token may be a numerical representation of an input signal, such as word, image, audio signal, video signal, etc. The dimension of the input sequence 1303, which may be denoted as SLᵢₙₚᵤₜ, may be the total number of tokens in the input sequence 1303. For the purpose of illustration and simplicity, SLᵢₙₚᵤₜ is 4. In other embodiments, the input sequence 1303 may have a different shape. For instance, the input sequence 1303 may be a 2D tensor. The dimension of the 2D tensor along the X axis may be SLᵢₙₚᵤₜ, while the dimension of the 2D tensor along the Y axis may be a batch size indicating the number of batches in the input sequence 1303.

The decoder 1320 computes an output tensor 1304, a self-attention key tensor 1305, a self-attention value tensor 1306, a cross-attention key tensor 1307, and a cross-attention value tensor 1308. In some embodiments, the shape of the output tensor 1304 may be denoted as [batch size, SLᵢₙₚᵤₜ, d_{model}]. The shape of the self-attention key tensor 1305 or the shape of the self-attention value tensor 1306 may be denoted as N x [batch size, h, SLᵢₙₚᵤₜ, d_{head}], where N is the number of identical layers in the decoder (e.g., the number of layers 1250 in the decoder block 1220), h is the total number of heads in a MHA layer, and d_{head} is the dimension of a query vector, key vector, or value vector. In some embodiments, d_{model}=h×d_{head}. The shape of the cross-attention key tensor 1307 or the shape of the cross-attention value tensor 1308 may be denoted as N×[batch size, h, SL_{encoder}, d_{head}].

The output tensor 1304 may be provided to the head 1330 and the head 1330 outputs a predicted token 1309. The shape of the token 1309 may be denoted as [batch size, 1]. For the purpose of illustration and simplicity, batch size is 1 in FIG. 13. In other embodiments, batch size may be a larger number. The predicted token 1309 may be stored in a buffer. In some embodiments, the predicted token 1309 may be used to update the input sequence 1303. For instance, the predicted token 1309 may be added to the right of the input sequence 1303. The updated input sequence may be used as the input sequence in the second inference phase. In the second inference phase, the decoder 1320 may receive the updated input sequence and the output tensor 1302 for predicting another token. The output tensor 1302 may remain the same during inference of the decoder 1320.

In some embodiments, the self-attention key tensor 1305 and the self-attention value tensor 1306 may be provided to a self-attention layer in the decoder 1320, an example of such a self-attention layer is the MHA layer 151. The self-attention key tensor 1305 may be stored in a self-attention key cache. The self-attention key cache may have the same shape as the self-attention key tensor 1305. The self-attention value tensor 1306 may be stored in a self-attention value cache. The self-attention value cache may have the same shape as the self-attention value tensor 1306.

In some embodiments, the decoder 1320 computes the self-attention key tensor 1305 and the self-attention value tensor 1306 from the input sequence 1303. The input sequence 1303 may be dynamic during inference of the decoder 1320. For instance, a new token may be added to the input sequence 1303 after each inference phase, as described above. As the input sequence 1303 changes, the self-attention key tensor 1305 and the self-attention value tensor 1306 would also change. For instance, the dimension of the self-attention key tensor 1305 or the self-attention value tensor 1306 along the X axis may increase as SLᵢₙₚᵤₜ increases. The self-attention key cache and the self-attention value cache may change during all the inference phases of the decoder 1320 to accommodate the changes in the self-attention key tensor 1305 and the self-attention value tensor 1306.

In some embodiments, the cross-attention key tensor 1307 and the cross-attention value tensor 1306 may be provided to a cross-attention layer in the decoder 1320, an example of such a cross-attention layer is the MHA layer 153. The cross-attention key tensor 1307 may be stored in a cross-attention key cache. The cross-attention key cache may have the same shape as the cross-attention key tensor 1307. The cross-attention value tensor 1308 may be stored in a cross-attention value cache. The cross-attention value cache may have the same shape as the cross-attention value tensor 1308. In some embodiments, the decoder 1320 computes the cross-attention key tensor 1307 and the cross-attention value tensor 1306 from the output tensor 1302 generated in the encoder 1310. As the output tensor 1302 does not change during inference of the decoder 1320, the cross-attention key tensor 1307 and the cross-attention value tensor 1306 may remain the same during all the inference phases of the decoder 1320. The cross-attention key cache and the cross-attention value cache may remain the same during all the inference phases of the decoder 1320.

FIG. 14 illustrates subsequent inference processes of the transformer model 1300 in FIG. 13, in accordance with various embodiments. In the second inference phase, the decoder 1320 may reuse the self-attention key tensor 1305, self-attention value tensor 1306, cross-attention key tensor 1307, and cross-attention value tensor 1308. The decoder 1320 also receives the predicted token 1309. The decoder 1320 may compute self-attention key vectors from the predicted token 1309 and concatenate the self-attention key vectors with the self-attention key tensor 1305 to generate a new self-attention key tensor 1315. For instance, a self-attention key vector for each head may be added to the right of a self-attention key matrix in the self-attention key tensor 1305, and the self-attention key vector and the self-attention key matrix may correspond to the same head. The elements highlighted with a dot pattern in the self-attention key tensor 1315 are the self-attention key vectors generated from the predicted token 1309.

Similarly, the decoder 1320 may compute self-attention value vectors from the predicted token 1309 and concatenate the self-attention value vectors with the self-attention value tensor 1306 to generate a new self-attention value tensor 1316. For instance, a self-attention value vector for each head may be added to the right of a self-attention value matrix in the self-attention value tensor 1306, and the self-attention value vector and the self-attention value matrix may correspond to the same head. The elements highlighted with a dot pattern in the self-attention value tensor 1316 are the self-attention value vectors generated from the predicted token 1309.

The decoder 1320 also generates an output tensor 1314. The decoder 1320 may generate the output tensor 1314 using the new self-attention key tensor 1315 and new self-attention value tensor 1316. The output tensor 1314 is used by the head 1330 to generate another predicted token 1319. The predicted token 1319 is the output of the transformer model 1300 in the second inference phase.

One or more other subsequent inference processes may be conducted. In each subsequent inference phase, the decoder 1320 receives a token predicted in the previous inference phase, a self-attention key tensor generated in the previous inference phase, a self-attention value tensor generated in the previous inference phase, the cross-attention key tensor 1307, and the cross-attention value tensor 1308. The decoder 1320 may, in the subsequent inference phase, generate a larger self-attention key tensor and a larger self-attention value tensor, in addition to an output tensor which can be used by the head 1330 to predict a new token.

In embodiments where the total number of inference phases is N, the input sequence 1303 is updated to an input sequence 1313 after N−1 inference phases. In the last inference phase (i.e., the Nth inference phase), the decoder 1320 may receive the predicted token generated in the (N−1)th inference phase, the self-attention key tensor generated in the (N−1)th inference phase, the self-attention value tensor generated in the (N−1)th inference phase, the cross-attention key tensor 1307, and the cross-attention value tensor 1308. The decoder 1320 may generate a self-attention key tensor 1325 and a self-attention value tensor 1326 using the predicted token generated in the (N−1)th inference phase, the self-attention key tensor generated in the (N−1)th inference phase, and the self-attention value tensor generated in the (N−1)th inference phase. The dimensions of the self-attention key tensor 1325 or self-attention value tensor 1326 along the X axis is SLᵢₙₚᵤₜ+N. The decoder 1320 also generates an output tensor 1324, which is used by the head 1330 to generate the last predicted token 1329. The N tokens predicted by the transformer model in the N inference phases may constitute an output tensor 1339, which may be the final output of the transformer model.

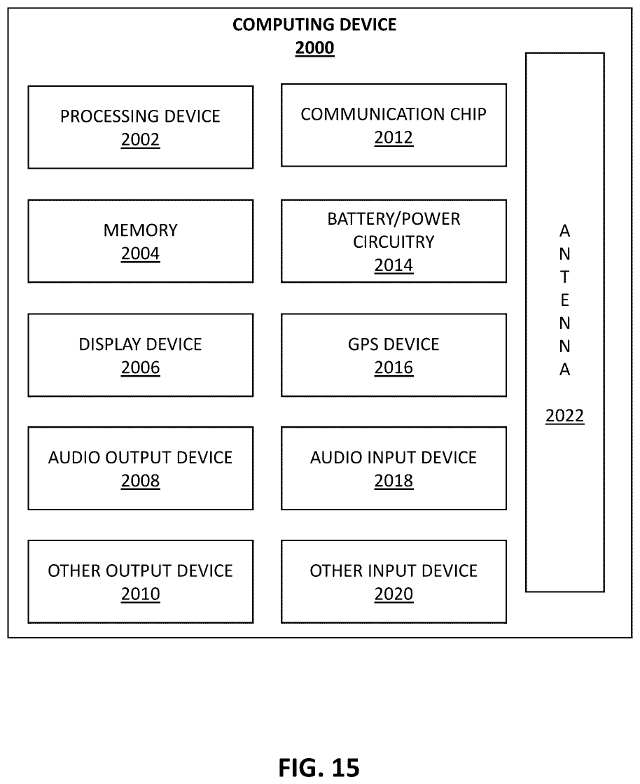

FIG. 15 is a block diagram of an example computing device 2000, in accordance with various embodiments. A number of components are illustrated in FIG. 15 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 15, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry (e.g., connectors and supporting circuitry) to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The processing device 2002 may be or include the IC device 100 in FIG. 1 or the integrated system 300 in FIG. 3. The computing device 2000 may include a memory 2004, which may itself include one or more memory devices such as volatile memory (e.g., DRAM), nonvolatile memory (e.g., ROM, high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for DNN execution, such as operations performed by the IC device 100 in FIG. 1, operations performed by the integrated system 300 in FIG. 3, or the method 1100 in FIG. 11. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an IC device, including a vector operation unit, the vector operation unit to perform one or more vector operations of a neural network model based on an input of the neural network model; a plurality of compute units, the plurality of compute units to perform one or more matrix multiplication operations of the neural network model based on an output of the vector operation unit; a plurality of memory blocks, a memory block coupled with a compute unit through a via; and an interconnect fabric coupled with the vector operation unit and the plurality of compute units.

Example 2 provides the IC device of example 1, further including an interface unit, the interface unit to receive the input of the neural network model and to transfer the input of the neural network model to the vector operation unit.

Example 3 provides the IC device of example 1 or 2, in which the vector operation unit includes one or more vector registers and one or more scalar registers, in which data is transferred between the memory block and the one or more vector registers or the one or more scalar registers through the interconnect fabric.

Example 4 provides the IC device of any one of examples 1-3, in which the one or more vector operations includes an embedding operation, a rotary operation, an activation function, a RMS normalization, or an inverse operation.

Example 5 provides the IC device of example any one of claims 1-4, in which the compute unit is a multiply-add unit, in which data is transferred between the multiply-add unit and the memory block through the via.

Example 6 provides the IC device of any one of examples 1-5, in which the memory block is at least part of a sequential random-access memory or a sequential ROM.

Example 7 provides the IC device of any one of examples 1-6, further including a sequence of adders on the interconnect fabric, in which data computed by a first adder in the sequence of adders is transferred to a second adder in the sequence of adders through the interconnect fabric.

Example 8 provides the IC device of any one of examples 1-7, in which the one or more vector operations include one or more activation functions of the neural network model, in which the vector operation unit includes one or more look-up tables, the one or more look-up tables to store precomputed values of the one or more activation functions.

Example 9 provides the IC device of any one of examples 1-8, in which the vector operation unit, the plurality of compute units, and the interconnect fabric are in a first die, in which the plurality of memory blocks are in a second die that is over the first die, in which the via extends between the first die and the second die.

Example 10 provides the IC device of any one of examples 1-9, further including a flow control unit, the flow control unit to orchestrate the one or more vector operations and the one or more matrix multiplication operations based on a timing sequence of the neural network model.

Example 11 provides one or more non-transitory computer-readable media storing instructions executable to perform operations for executing a neural network model, the operations including receiving, by an interface unit, an input of the neural network model; performing, by a vector operation unit, one or more vector operations in the neural network model on the input; transmitting, through an interconnect fabric, an output of the vector operation unit to a plurality of multiply-add units; performing, by the plurality of multiply-add units and a plurality of adders on the interconnect fabric, one or more matrix multiplication operations in the neural network model based on the output of the vector operation unit; and orchestrating, by a flow control unit, the one or more vector operations and the one or more matrix multiplication operations based on a timing sequence of the neural network model.

Example 12 provides the one or more non-transitory computer-readable media of example 11, in which the operations further include storing input data or output data of the plurality of multiply-add units in a plurality of memory blocks, in which each multiply-add unit of the plurality of multiply-add units is coupled with a different memory block of the plurality of memory blocks.

Example 13 provides the one or more non-transitory computer-readable media of example 12, in which the plurality of memory blocks includes a sequential random-access memory or a sequential ROM.

Example 14 provides the one or more non-transitory computer-readable media of example 12 or 13, in which the operations further include transferring data between a memory block and a corresponding multiply-add unit through a via, in which the plurality of multiply-add units are arranged in a logic die, the plurality of memory blocks are arranged in a memory die, and the via extends between the logic die and the memory die.

Example 15 provides the one or more non-transitory computer-readable media of any one of examples 11-14, in which performing the one or more matrix multiplication operations includes transferring data points computed by two or more multiply-add units of the plurality of multiply-add units to a first adder of the plurality of adders, in which the first adder is to compute a sum of the data points.

Example 16 provides the one or more non-transitory computer-readable media of any one of examples 11-15, in which performing the one or more vector operations includes performing one or more activation functions of the neural network model based on precomputed values of the one or more activation functions, the precomputed values of the one or more activation functions stored in one or more look-up tables of the vector operation unit.

Example 17 provides an IC device, including a memory die including a plurality of memory blocks; and a logic die placed over the memory die, the logic die to perform matrix multiplication operations of a neural network model, the logic die including a plurality of multiply-add units, an interconnect fabric coupled with the plurality of multiply-add units to receive data points from the plurality of multiply-add units, and a plurality of adders on the interconnect fabric, the plurality of adders to accumulate the data points.

Example 18 provides the IC device of example 17, further including a plurality of vias, a via extending between a memory block in the memory die and a compute unit in the logic die.

Example 19 provides the IC device of example 17 or 18, in which the logic die further includes a vector operation unit, the vector operation unit to perform one or more vector operations of the neural network model.

Example 20 provides the IC device of example 19, in which the vector operation unit includes one or more vector registers and one or more scalar registers, in which data is transferred between the memory block and the one or more vector registers or the one or more scalar registers through the interconnect fabric.

Example 21 provides the IC device of any one of examples 17-20, in which the logic die further includes an interface unit, the interface unit to receive an input or send out an output of the logic die.

Example 22 provides the IC device of any one of examples 17-21, in which the memory block is at least part of a sequential random-access memory or a sequential ROM.

Example 23 provides the IC device of any one of examples 17-22, where the plurality of adders are arranged in a sequence, in which data computed by a first adder in the sequence is transferred to a second adder in the sequence through the interconnect fabric.

Example 24 provides the IC device of example 13, in which the first adder is to receive data points computed by two or more multiply-add units of the plurality of multiply-add units and to compute a sum of the data points.

Example 25 provides the IC device of any one of examples 17-24, in which the logic die further includes a flow control unit, the flow control unit to orchestrate the one or more vector operations and the one or more matrix multiplication operations based on a timing sequence of the neural network model.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device, comprising:
a vector operation unit, the vector operation unit to perform one or more vector operations of a neural network model based on an input of the neural network model;
a plurality of compute units, the plurality of compute units to perform one or more matrix multiplication operations of the neural network model based on an output of the vector operation unit;
a plurality of memory blocks, a memory block coupled with a compute unit through a via; and
an interconnect fabric coupled with the vector operation unit and the plurality of compute units.

2. The IC device of claim 1, further comprising:
an interface unit, the interface unit to receive the input of the neural network model and to transfer the input of the neural network model to the vector operation unit.

3. The IC device of claim 1, wherein the vector operation unit comprises one or more vector registers and one or more scalar registers, wherein data is transferred between the memory block and the one or more vector registers or the one or more scalar registers through the interconnect fabric.

4. The IC device of claim 1, wherein the one or more vector operations comprises an embedding operation, a rotary operation, an activation function, a root mean square normalization, or an inverse operation.

5. The IC device of claim 1, wherein the compute unit is a multiply-add unit, wherein data is transferred between the multiply-add unit and the memory block through the via.

6. The IC device of claim 1, wherein the memory block is at least part of a sequential random-access memory or a sequential read-only memory.

7. The IC device of claim 1, further comprising:
a sequence of adders on the interconnect fabric, wherein data computed by a first adder in the sequence of adders is transferred to a second adder in the sequence of adders through the interconnect fabric.

8. The IC device of claim 1, wherein the one or more vector operations comprise one or more activation functions of the neural network model, wherein the vector operation unit comprises one or more look-up tables, the one or more look-up tables to store precomputed values of the one or more activation functions.

9. The IC device of claim 1, wherein the vector operation unit, the plurality of compute units, and the interconnect fabric are in a first die, wherein the plurality of memory blocks are in a second die that is over the first die, wherein the via extends between the first die and the second die.

10. The IC device of claim 1, further comprising:
a flow control unit, the flow control unit to orchestrate the one or more vector operations and the one or more matrix multiplication operations based on a timing sequence of the neural network model.

11. One or more non-transitory computer-readable media storing instructions executable to perform operations for executing a neural network model, the operations comprising:
receiving, by an interface unit, an input of the neural network model;
performing, by a vector operation unit, one or more vector operations in the neural network model on the input;
transmitting, through an interconnect fabric, an output of the vector operation unit to a plurality of multiply-add units;
performing, by the plurality of multiply-add units and a plurality of adders on the interconnect fabric, one or more matrix multiplication operations in the neural network model based on the output of the vector operation unit; and
orchestrating, by a flow control unit, the one or more vector operations and the one or more matrix multiplication operations based on a timing sequence of the neural network model.

12. The one or more non-transitory computer-readable media of claim 11, wherein the operations further comprise:
storing input data or output data of the plurality of multiply-add units in a plurality of memory blocks,
wherein each multiply-add unit of the plurality of multiply-add units is coupled with a different memory block of the plurality of memory blocks.

13. The one or more non-transitory computer-readable media of claim 12, wherein the plurality of memory blocks includes a sequential random-access memory or a sequential read-only memory.

14. The one or more non-transitory computer-readable media of claim 12, wherein the operations further comprise:
transferring data between a memory block and a corresponding multiply-add unit through a via,
wherein the plurality of multiply-add units are arranged in a logic die, the plurality of memory blocks are arranged in a memory die, and the via extends between the logic die and the memory die.

15. The one or more non-transitory computer-readable media of claim 11, wherein performing the one or more matrix multiplication operations comprises:
transferring data points computed by two or more multiply-add units of the plurality of multiply-add units to a first adder of the plurality of adders,
wherein the first adder is to compute a sum of the data points.

16. The one or more non-transitory computer-readable media of claim 11, wherein performing the one or more vector operations comprises:
performing one or more activation functions of the neural network model based on precomputed values of the one or more activation functions, the precomputed values of the one or more activation functions stored in one or more look-up tables of the vector operation unit.

17. An integrated circuit (IC) device, comprising:
a memory die comprising a plurality of memory blocks; and
a logic die placed over the memory die, the logic die to perform matrix multiplication operations of a neural network model, the logic die comprising:
a plurality of multiply-add units,
an interconnect fabric coupled with the plurality of multiply-add units to receive data points from the plurality of multiply-add units, and
a plurality of adders on the interconnect fabric, the plurality of adders to accumulate the data points.

18. The IC device of claim 17, further comprising:
a plurality of vias, a via extending between a memory block in the memory die and a compute unit in the logic die.

19. The IC device of claim 17, wherein the logic die further comprises:
an interface unit, the interface unit to receive an input of the logic die; and
a vector operation unit, the vector operation unit to perform one or more vector operations of the neural network model based on the input,
wherein the vector operation unit comprises one or more vector registers and one or more scalar registers, wherein data is transferred between the memory block and the one or more vector registers or the one or more scalar registers through the interconnect fabric.

20. The IC device of claim 17, where the plurality of adders are arranged in a sequence, wherein data computed by a first adder in the sequence is transferred to a second adder in the sequence through the interconnect fabric, wherein the first adder is to receive data points computed by two or more multiply-add units of the plurality of multiply-add units and to compute a sum of the data points.
